(19) United States
(12) Patent Application Publication
(10) Pub. No.: US 2022/0262347 A1
(43) Pub. Date: Aug. 18, 2022

(54) COMPUTER PROGRAM, SERVER DEVICE, TERMINAL DEVICE, LEARNED MODEL, PROGRAM GENERATION METHOD, AND METHOD

(71) Applicant: GREE, Inc., Tokyo (JP)

(72) Inventor: Tatsuma Ishihara, Tokyo (JP)

(73) Assignee: GREE, Inc., Tokyo (JP)

(21) Appl. No.: 17/732,492

(22) Filed: Apr. 28, 2022

Related U.S. Application Data
(63) Continuation-in-part of application No. PCT/JP2020/039780, filed on Oct. 22, 2020.

(30) Foreign Application Priority Data
Oct. 31, 2019 (JP) 2019-198078

(51) Int. Cl. G10L 15/14; G10L 15/06; G10L 25/60; G10L 15/22

(52) U.S. Cl. CPC G10L 15/14; G10L 15/063; G10L 15/30; G10L 15/22; G10L 25/60

(57) ABSTRACT

Computer-readable storage media, server devices, terminal devices and methods are disclosed for voice conversion. In one example, computer-readable instructions are executed by a processor to: adjust a weight related to a first encoder and a weight related to a second encoder so as to decrease a reconstruction error between a first voice and a generated first voice to be smaller than a predetermined value, in which the generated first voice is generated by using first language data acquired from the first voice by using the first encoder, second language data acquired from a second voice by using the first encoder, and second non-language data acquired from the second voice by using the second encoder.

### CROSS-REFERENCE TO RELATED APPLICATIONS

This application is a bypass continuation-in-part of International Application No. PCT/JP2020/039780, filed Oct. 22, 2020, which application claims the benefit of and priority to Japanese Patent Application No. 2019-198078, titled “Computer Program, Server Device, Terminal Device, Machine-learned Model, Program Generation Method, and Method” and filed on Oct. 31, 2019. The entire disclosures of International Application No. PCT/JP2020/039780 and Japanese Patent Application No. 2019-198078 are incorporated by reference as if set forth fully herein.

### BACKGROUND

Techniques for computer-implemented voice conversion are discussed in the following documents:

Tomoki Toda, “Sound Quality Conversion Technology Based on Establishment Model,” Journal of Acoustical Society of Japan, Vol. 67, No. 1 (2011), pp. 34-39; Ju-chieh Chou, et al., “One-shot Voice Conversion by Separating Speaker and Content Representations with Instance Normalization,” downloaded on Aug. 14, 2019 from https://arvix.org/abs/1904.05742; and

Kaizhi Qian, et al., “AUTOVC: Zero-Shot Voice Style Transfer with Only Autoencoder Loss” Downloaded on August 14, 2019 from https://arvix.org/abs/1905.05879.

The entireties of these three documents are submitted herewith this application and are hereby incorporated by reference herein as if set forth full herein.

### SUMMARY

Computer-readable storage media, server devices, terminal devices and methods are disclosed for voice conversion. The following examples are illustrative but non-limiting.

A computer program according to an aspect is executed by a processor to cause the processor to function to: adjust a weight related to a first encoder and a weight related to a second encoder so as to decrease a reconstruction error between a first voice and a generated first voice to be smaller than a predetermined value, in which the generated first voice is generated by using first language data produced from the first voice by using the first encoder, second language data produced from a second voice by using the first encoder, and second non-language data produced from the second voice by using the second encoder.

A computer program according to another aspect is executed by a processor to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder.

A computer program according to another aspect is executed by a processor to: produce an input voice to be converted; and generate a converted voice by using an adjusted first encoder and the input voice to be converted, in which the adjusted first encoder is adjusted so as to decrease a reconstruction error between a first voice and a generated first voice to be smaller than a predetermined value, and the generated first voice is generated by using first language data produced from the first voice by using the first encoder, second language data produced from a second voice by using the first encoder, and second non-language data produced from the second voice by using a second encoder.

A computer program according to another aspect is executed by a processor to: produce a reference voice; and generate a reference parameter μ by using a first encoder and a second encoder for which a weight related to the first encoder and a weight related to the second encoder are adjusted so as to decrease a reconstruction error between a first voice and a generated first voice to be smaller than a predetermined value, in which the generated first voice is generated by using first language data produced from the first voice by using the first encoder, second language data produced from a second voice by using the first encoder, and second non-language data produced from the second voice by using the second encoder, and the reference parameter μ is generated by using reference language data generated by applying the first encoder to the reference voice, and reference non-language data generated by applying the second encoder to the reference voice.

A computer program according to another aspect is executed by a processor to: produce an input voice to be converted; produce language data of input voice from the input voice to be converted by using a first encoder configured to produce language data from a voice; and generate a converted voice by using the language data of input voice and data based on a reference voice.

A machine-learning model according to an aspect is executed by a processor to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder.

A machine-learning model according to another aspect is executed by a processor to: produce an input voice to be converted; and generate a voice by using the input voice to be converted and the first encoder for which a weight related to the first encoder and a weight related to the second encoder are adjusted so as to decrease a reconstruction error between a first voice and a generated first voice to be smaller than a predetermined value, in which the generated first voice is generated by using first language data produced from the first voice by using the first encoder, second language data produced from a second voice by using the first encoder, and second non-language data produced from the second voice by using the second encoder.

A machine-learning model according to another aspect is executed by a processor to: produce a reference voice; and generate a reference parameter μ by using the first encoder and the second encoder for which a weight related to the first encoder and a weight related to the second encoder are adjusted so as to decrease a reconstruction error between a first voice and a generated first voice to be smaller than a predetermined value, in which the reference parameter μ is generated by using reference language data generated by applying the first encoder to the reference voice, and reference non-language data generated by applying the second encoder to the reference voice, and the generated first voice is generated by using first language data produced from the first voice by using the first encoder, second language data produced from a second voice by using the first encoder, and second non-language data produced from the second voice by using the second encoder.

A server device according to an aspect includes: a processor, in which the processor executes a computer-readable command to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder.

A server device according to another aspect includes: a processor, in which the processor executes a computer-readable command to: produce an input voice to be converted; and generate a voice by using the input voice to be converted and the first encoder for which a weight related to the first encoder and a weight related to the second encoder are adjusted so as to decrease a reconstruction error between a first voice and a generated first voice to be smaller than a predetermined value, and the generated first voice is generated by using first language data produced from the first voice by using the first encoder, second language data produced from a second voice by using the first encoder, and second non-language data produced from the second voice by using the second encoder.

A server device according to another aspect includes: a processor, in which the processor executes a computer-readable command to: produce a reference voice; and generate a reference parameter μ by using the first encoder and the second encoder for which a weight related to the first encoder and a weight related to the second encoder are adjusted so as to decrease a reconstruction error between a first voice and a generated first voice to be smaller than a predetermined value, the reference parameter μ is generated by using reference language data generated by applying the first encoder to the reference voice, and reference non-language data generated by applying the second encoder to the reference voice, and the generated first voice is generated by using first language data produced from the first voice by using the first encoder, second language data produced from a second voice by using the first encoder, and second non-language data produced from the second voice by using the second encoder.

A server device according to another aspect includes: a processor, in which the processor executes a computer-readable command to: produce an input voice to be converted; produce language data of input voice from the input voice to be converted by using a first encoder configured to produce language data from a voice; and generate a converted voice by using the language data of input voice and data based on a reference voice.

A program generation method according to an aspect is executed by a processor that executes a computer-readable command, the program generation method including: generating a program configured to produce first language data from a first voice by using a first encoder, produce second language data from a second voice by using the first encoder, produce second non-language data from the second voice by using a second encoder, generate a reconstruction error between the first voice and a generated first voice generated using the first language data, the second language data, and the second non-language data, and adjust a weight related to the first encoder and a weight related to the second encoder in such a manner that the reconstruction error is a predetermined value or less.

A program generation method according to another aspect is executed by a processor that executes a computer-readable command, the program generation method including: generating a program configured to produce a reference voice and generate a voice corresponding to a case where an input voice to be converted is produced using the reference voice and the first encoder for which a weight related to the first encoder and a weight related to the second encoder are adjusted so as to decrease a reconstruction error between a first voice and a generated first voice to be smaller than a predetermined value, in which the generated first voice is generated by using first language data produced from the first voice by using the first encoder, second language data produced from a second voice by using the first encoder, and second non-language data produced from the second voice by using the second encoder.

A method according to an aspect is executed by a processor that executes a computer-readable command, in which the processor executes the command to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder.

A method according to another aspect is executed by a processor that executes a computer-readable command, in which the processor executes the command to: produce an input voice to be converted; and generate a voice by using the input voice to be converted and the first encoder for which a weight related to the first encoder and a weight related to the second encoder are adjusted so as to decrease a reconstruction error between a first voice and a generated first voice to be smaller than a predetermined value, and the generated first voice is generated by using first language data produced from the first voice by using the first encoder, second language data produced from a second voice by using the first encoder, and second non-language data produced from the second voice by using the second encoder.

A method according to another aspect is executed by a processor that executes a computer-readable command, the method including: producing a reference voice; and generating a reference parameter μ by using the first encoder and the second encoder for which a weight related to the first encoder and a weight related to the second encoder are adjusted so as to decrease a reconstruction error between a first voice and a generated first voice to be smaller than a predetermined value, the reference parameter μ is generated by using reference language data generated by applying the first encoder to the reference voice, and reference non-language data generated by applying the second encoder to the reference voice, and the generated first voice is generated by using first language data produced from the first voice by using the first encoder, second language data produced from a second voice by using the first encoder, and second non-language data produced from the second voice by using the second encoder.

A method according to another aspect is executed by a processor that executes a computer-readable command, the method including: producing an input voice to be converted; producing language data of input voice from the input voice to be converted by using a first encoder configured to produce language data from a voice; and generate a converted voice by using the language data of input voice and data based on a reference voice.

This Summary is provided to introduce a selection of concepts in a simplified form that are further described below in the Detailed Description. All trademarks used herein remain the property of their respective owners. This Summary is not intended to identify key features or essential features of the claimed subject matter, nor is it intended to be used to limit the scope of the claimed subject matter. The foregoing and other objects, features, and advantages of the disclosed subject matter will become more apparent from the following Detailed Description, which proceeds with reference to the accompanying figures.

### BRIEF DESCRIPTION OF THE DRAWINGS

FIG. 1 is a block diagram illustrating an example of a configuration of a system according to an embodiment.

FIG. 2 is a block diagram schematically illustrating n example of a hardware configuration of a server device 20 (terminal device 30) illustrated in FIG. 1.

FIG. 3 is a block diagram schematically illustrating an example of functions of the system according to an embodiment.

FIG. 4 illustrates an example showing a viewpoint of the system according to an embodiment.

FIG. 5 illustrates an example showing a viewpoint of the system according to an embodiment.

FIG. 6 illustrates an example showing a viewpoint of the system according to an embodiment.

FIG. 7 illustrates an example of a processing flow of a system according to an embodiment.

FIG. 8 illustrates an example of a processing flow of a system according to an embodiment.

FIG. 9 illustrates an example of a processing flow of a system according to an embodiment.

FIG. 10 illustrates an example of a processing flow of a system according to an embodiment.

FIG. 11 illustrates an example of a screen generated by the system according to an embodiment.

FIG. 12 is a block diagram illustrating an example of functions of the system according to an embodiment.

FIG. 13 is a block diagram schematically illustrating an example of a hardware configuration according to an embodiment.

FIG. 14 illustrates an example of a configuration related to machine learning according to an embodiment.

### DETAILED DESCRIPTION

This disclosure is set forth in the context of representative embodiments that are not intended to be limiting in any way.

As used in this application the singular forms “a”, “an”, and “the” include the plural forms unless the context clearly dictates otherwise. Additionally, the term “includes” means “comprises”. Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce”, “generate”, “display”, “receive”, “evaluate”, and “distribute” to describe the disclosed methods. These terms are high-level descriptions of the actual operations that are performed. The actual operations that correspond to these terms will vary depending on the particular implementation and are readily discernible by one of ordinary skill in the art having the benefit of the present disclosure.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented using computer-executable instructions stored on one or more computer-readable media (e.g., non-transitory computer-readable storage media, such as one or more optical media discs, volatile memory components (such as DRAM or SRAM), or nonvolatile memory components (such as hard drives and solid state drives (SSDs))) and executed on a computer (e.g., any commercially available computer, including smart phones or other mobile devices that include computing hardware).

Any of the computer-executable instructions for implementing the disclosed techniques, as well as any data created and used during implementation of the disclosed embodiments, can be stored on one or more computer-readable media (e.g., non-transitory computer-readable storage media). The computer-executable instructions can be part of, for example, a dedicated software application, or a software application that is accessed or downloaded via a web browser or other software application (such as a remote computing application). Such software can be executed, for example, on a single local computer (e.g., as an agent executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

That is, the communication line in the communication tool can include a mobile telephone network, a wireless network (e.g., RF connections via Bluetooth, WiFi (such as IEEE 802.11a/b/n), WiMax, cellular, satellite, laser, infrared), a fixed telephone network, the Internet, an intranet, a local area network (LAN), a wide-area network (WAN), and/or an Ethernet network, without being limited thereto. In a virtual host environment, the communication line(s) can be a virtualized network connection provided by the virtual host.

Hereinafter, various embodiments of the disclosed technology will be described with reference to the accompanying drawings. In addition, it should be noted that components illustrated in a certain drawing may be omitted in another drawing for convenience of description. Furthermore, it should be noted that, although the accompanying drawings disclose an embodiment of the disclosed technology, the accompanying drawings are not necessarily drawn to scale.

1. Example of System

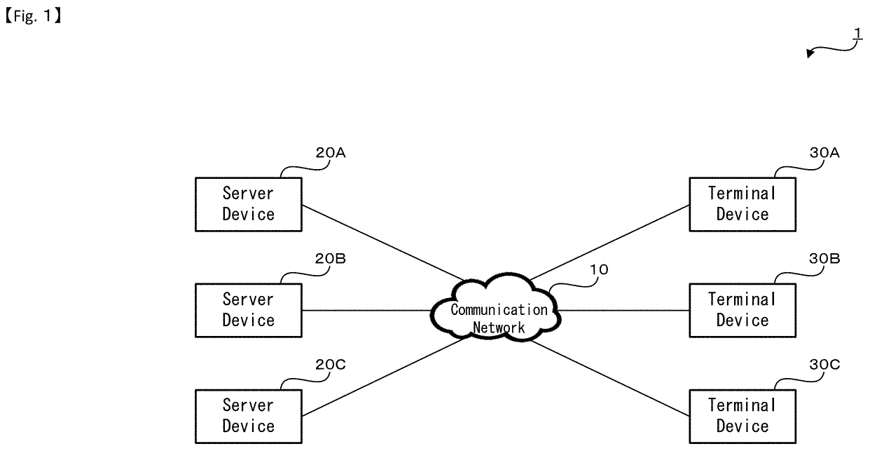

FIG. 1 is a block diagram illustrating an example of a configuration of a system according to an embodiment. As illustrated in FIG. 1, a system 1 may include one or more server devices 20 connected to a communication network 10 and one or more terminal devices 30 connected to the communication network 10. Note that, in FIG. 1, three server devices 20A to 20C are illustrated as an example of the server devices 20, and three terminal devices 30A to 30C are illustrated as an example of the terminal devices 30. However, one or more server devices 20 other than these can be connected as the server devices 20 to the communication network 10, and one or more terminal devices 30 other than these can be connected as the terminal devices 30 to the communication network 10. Note that, in the present application, the term “system” may include both the server device and the terminal device, or may be used as a term indicating only the server device or only the terminal device. That is, the system may be in any aspect of only the server device, only the terminal device, and both the server device and the terminal device. Furthermore, one or more server devices and one or more terminal devices may be provided.

Furthermore, the system may be an data processing apparatus on a cloud. Furthermore, the system constitutes a virtual data processing apparatus, and may be logically configured as one data processing apparatus. In addition, an owner and an administrator of the system may be different.

The communication network 10 may be, but is not limited to, a mobile telephone network, a wireless LAN, a fixed telephone network, the Internet, an intranet, Ethernet, a combination thereof, or the like.

The server device 20 may be able to perform an operation such as machine learning, application of a machine-learned (trained) model, generation of a parameter, and/or conversion of an input voice by executing an installed specific application. Alternatively, the terminal device 30 may receive, from the server device 20, and display a web page (for example, an HTML document, and in some examples, an HTML document encoded with an executable code such as JavaScript or PHP code) by executing an installed web browser, and may be able to perform an operation such as machine learning, application of a machine-learned (trained) model, generation of a parameter, and/or conversion of an input voice. The server device can be configured to implement a machine learning unit using any one or more of the following machine learning models after training the model, including: a trained random forest, a trained artificial neural network (or as used herein, simply “neural network” or “ANN”), a trained support vector machine, a trained decision tree, a trained gradient boost machine, a trained logistic regression, or a trained linear discriminant analysis. As used herein, machine-learned describes a machine learning model that has been trained using supervised learning. For example, a machine learning model can be trained by iteratively applying training data to the model, evaluating the output of the model, and adjusting weights of the machine learning model to reduce errors between the specified and observed outputs of the machine learning model.

The terminal device 30 is any terminal device capable of performing such an operation, and may be, but is not limited to, a smartphone, a tablet PC, a mobile phone (feature phone), a personal computer, or the like.

2. Hardware Configuration of Each Device

Next, an example of a hardware configuration of each of the server device 20 and the terminal device 30, and a hardware configuration in a computing environment of another aspect will be described.

2-1. Hardware Configuration of Server Device 20

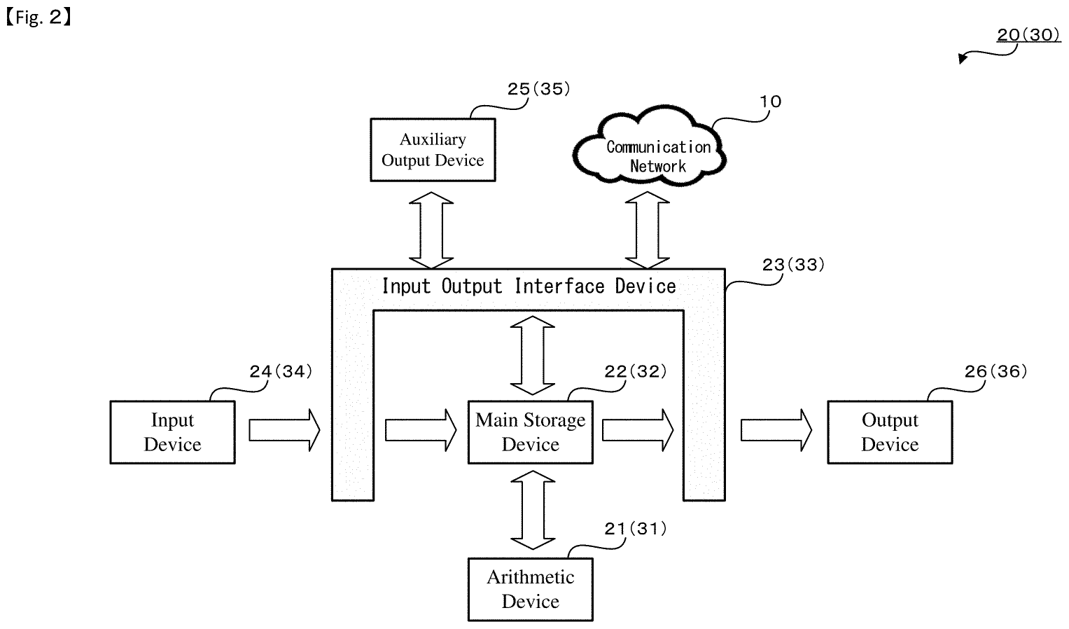

An example of the hardware configuration of the server device 20 will be described with reference to FIG. 2. FIG. 2 is a block diagram schematically illustrating an example of the hardware configuration of the server device 20 (terminal device 30) illustrated in FIG. 1 (note that, in FIG. 2, reference signs in parentheses are described in association with each terminal device 30 as described later).

As illustrated in FIG. 2, the server device 20 can mainly include an arithmetic device 21, a main storage device 22, and an input/output interface device 23. The server device 20 can further include an input device 24 and an auxiliary output device 26. These devices may be connected by a data bus and/or a control bus.

The arithmetic device 21 performs an arithmetic operation by using a command and data stored in the main storage device 22, and stores a result of the arithmetic operation in the main storage device 22. Furthermore, the arithmetic device 21 can control the input device 24, an auxiliary storage device 25, the output device 26, and the like via the input/output interface device 23. The server device 20 may include one or more arithmetic devices 21. The arithmetic device 21 may include one or more central processing units (CPU), one or more microprocessors, and/or one or more graphics processing units (GPU).

The main storage device 22 has a storage function, and stores commands and data received from the input device 24, the auxiliary storage device 25, the communication network 10, and the like (the server device 20 and the like) via the input/output interface device 23, and the arithmetic operation result of the arithmetic device 21. The main storage device 22 can include, but is not limited to, a random access memory (RAM), a read-only memory (ROM), a flash memory, and/or the like.

The main storage device 22 can include computer-readable media such as volatile memory (e.g., registers, cache, random access memory (RAM)), non-volatile memory (e.g., read-only memory (ROM), EEPROM, flash memory) and storage (e.g., a hard disk drive (HDD), solid-state drive (SSD), magnetic tape, optical media), without being limited thereto. As should be readily understood, the terms computer-readable storage media and machine-readable storage media include the media for data storage such as memory and storage, and not transmission media such as modulated data signals or transitory signals.

The auxiliary storage device 25 is a storage device. The auxiliary storage device 25 may store commands and data (computer program) constituting the specific application, the web browser, or the like, and the commands and data (computer program) may be loaded to the main storage device 22 via the input/output interface device 23 under the control of the arithmetic device 21. The auxiliary storage device 25 may be, but is not limited to, a magnetic disk device and/or an optical disk device, a file server, or the like.

The input device 24 is a device that takes in data from the outside, and may be a touch panel, a button, a keyboard, a mouse, a sensor, and/or the like.

The output device 26 may be able to include, but is not limited to, a display device, a touch panel, a printer device, and/or the like. Furthermore, the input device 24 and the output device 26 may be integrated.

In such a hardware configuration, the arithmetic device 21 may be able to sequentially load the commands and data (computer program) constituting the specific application stored in the auxiliary storage device 25 to the main storage device 22, and perform the arithmetic operation on the loaded commands and data to control the output device 26 via the input/output interface device 23, or transmit and receive various pieces of data to and from other devices (for example, the server device 20 and other terminal devices 30) via the input/output interface device 23 and the communication network 10.

As the server device 20 has such a configuration and executes the installed specific application, operations such as machine learning, application of a trained machine learning model, generation of a parameter, and/or conversion of an input voice (including various operations to be described in detail later) may be able to be performed as described below. Furthermore, such an operation and the like may be performed by a user giving an instruction to the system, which is an example of the invention disclosed in the present application, by using the input device 24 or an input device 34 of the terminal device 30 described later. In the latter case, an instruction based on data produced by the input device 34 of the terminal device 30 may be transmitted to the server device 20 via a network to perform the operation. Furthermore, in a case where the program is executed on the arithmetic device 21, data to be displayed may be displayed on the output device 26 of the server device 20 as a system used by the user, or the data to be displayed may be transmitted to the terminal device 30 as a system used by the user via the network and displayed on an output device 36 of the terminal device 30.

2-2. Hardware Configuration of Terminal Device 30

An example of the hardware configuration of the terminal device 30 will be similarly described with reference to FIG. 2. As the hardware configuration of each terminal device 30, for example, the same hardware configuration as that of each server device 20 described above can be used. Therefore, reference signs for components included in each terminal device 30 are indicated in parentheses in FIG. 2.

As illustrated in FIG. 2, each terminal device 30 can mainly include an arithmetic device 31, a main storage device 32, an input/output interface device 33, the input device 34, an auxiliary storage device 35, and the output device 36. These devices are connected by a data bus and/or a control bus.

The arithmetic device 31, the main storage device 32, the input/output interface device 33, the input device 34, the auxiliary storage device 35, and the output device 36 can be substantially the same as the arithmetic device 21, the main storage device 22, the input/output interface device 23, the input device 24, the auxiliary storage device 25, and the output device 26 included in each server device 20 described above, respectively. However, capacities and capabilities of the arithmetic device and the storage device may be different.

In such a hardware configuration, the arithmetic device 31 can sequentially load commands and data (computer program) constituting a specific application stored in the auxiliary storage device 35 to the main storage device 32, and perform the arithmetic operation on the loaded commands and data to control the output device 36 via the input/output interface device 33, or transmit and receive various pieces of data to and from other devices (for example, each server device 20 and the like) via the input/output interface device 33 and the communication network 10.

As the terminal device 30 has such a configuration and executes the installed specific application, operations such as machine learning, application of a trained machine learning model, generation of a parameter, and/or conversion of an input voice (including various operations to be described in detail later) may be performed independently without undergoing processing in the server device, or may be executed in cooperation with the server device as described below. Furthermore, by executing an installed web browser or executing a specific application installed for the terminal device, a web page may be received from the server device 20 and displayed, and a similar operation may be able to be performed. In addition, such an operation and the like may be performed by the user giving an instruction to the system, which is an example of the invention disclosed in the present application, by using the input device 34. In addition, in a case where the program is executed on the arithmetic device 31, data to be displayed may be displayed on the output device 36 of the terminal device 30 as a system used by the user.

2-3. Hardware Configuration in Computing Environment of Other Aspects

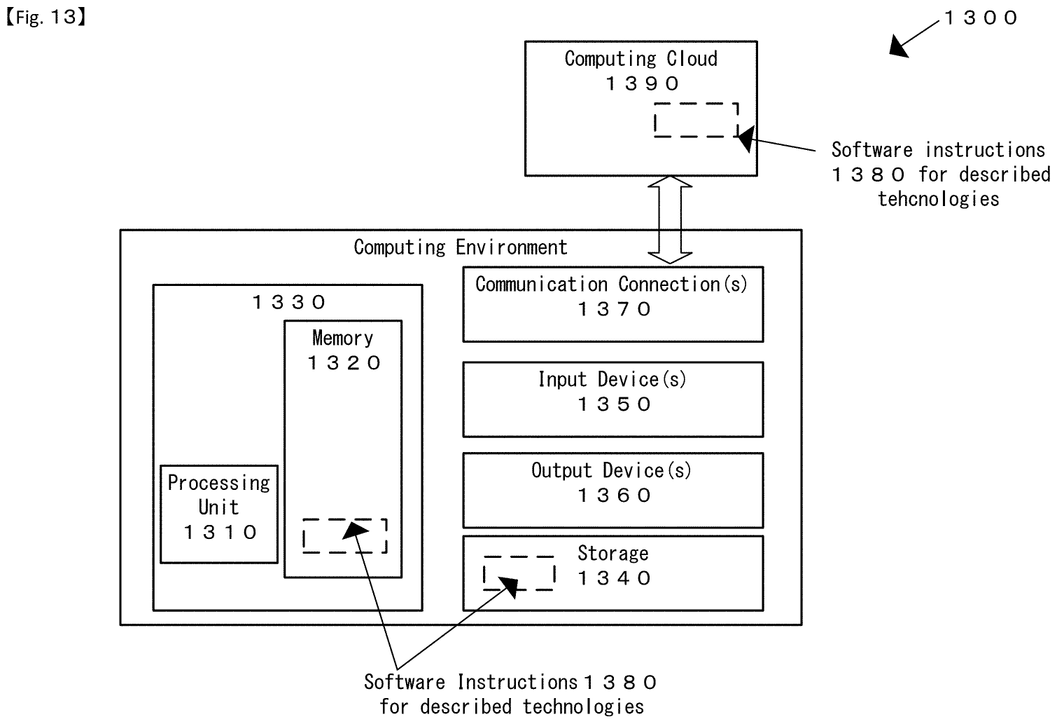

FIG. 13 illustrates a generalized example of a suitable computing environment 1300 in which embodiments, techniques, and technologies described in the present specification can be implemented. For example, the computing environment 1300 can implement any of a terminal device, a server system, and the like, as described herein.

The computing environment 1300 is not intended to suggest any limitation as to scope of use or functionality of the technology, as the technology may be implemented in diverse general-purpose or special-purpose computing environments. For example, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 13, the computing environment 1300 includes at least one central processing unit 1310 and memory 1320. In FIG. 13, this most basic configuration 1330 is included within a dashed line.

The central processing unit 1310 executes computer-executable instructions and may be a real or a virtual processor. In a multi-processing system, multiple processing units execute computer-executable instructions to increase processing power and as such, multiple processors can be running simultaneously. The memory 1320 may be volatile memory (e.g., registers, cache, RAM), non-volatile memory (e.g., ROM, EEPROM, flash memory, etc.), or some combination of the two. The memory 1320 stores software 1380, images, and video that can, for example, implement the technologies described herein. A computing environment may have additional features. For example, the computing environment 1300 includes storage 1340, one or more input devices 1350, one or more output devices 1360, and one or more communication connections 1370. An interconnection mechanism (not shown) such as a bus, a controller, or a network, interconnects the components of the computing environment 1300. Typically, operating system software (not shown) provides an operating environment for other software executing in the computing environment 1300, and coordinates activities of the components of the computing environment 1300.

The storage 1340 may be removable or non-removable, and includes magnetic disks, magnetic tapes or cassettes, CD-ROMs, CD-RWs, DVDs, or any other medium which can be used to store data and that can be accessed within the computing environment 1300. The storage 1340 stores instructions for the software 1380, plugin data, and messages, which can be used to implement technologies described herein.

The input device(s) 1350 may be a touch input device, such as a keyboard, keypad, mouse, touch screen display, pen, or trackball, a voice input device, a scanning device, or another device, that provides input to the computing environment 1400. For audio, the input device(s) 1350 may be a sound card or similar device that accepts audio input in analog or digital form, or a CD-ROM reader that provides audio samples to the computing environment 1300. The output device(s) 1360 may be a display, printer, speaker, CD-writer, or another device that provides output from the computing environment 1300.

The communication connection(s) 1370 enable communication over a communication medium (e.g., a connecting network) to another computing entity. The communication medium conveys data such as computer-executable instructions, compressed graphics data, video, or other data in a modulated data signal. The communication connection(s) 1370 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and destination agent data consumers. In a virtual host environment, the communication(s) connection(s)s can be a virtualized network connection provided by the virtual host.

Some embodiments of the disclosed methods can be performed using computer-executable instructions implementing all or a portion of the disclosed technology in a computing cloud 1390. For example, agents can be executing vulnerability scanning functions in the computing environment while agent platform (e.g., bridge) and destination agent data consumer service can be performed on servers located in the computing cloud 1390.

Computer-readable media are any available media that can be accessed within a computing environment 1300. By way of example, and not limitation, with the computing environment 1300, computer-readable media include memory 1320 and/or storage 1340. As should be readily understood, the term computer-readable storage media includes the media for data storage such as memory 1320 and storage 1340, and not transmission media such as modulated data signals.

3. Function of Each Device

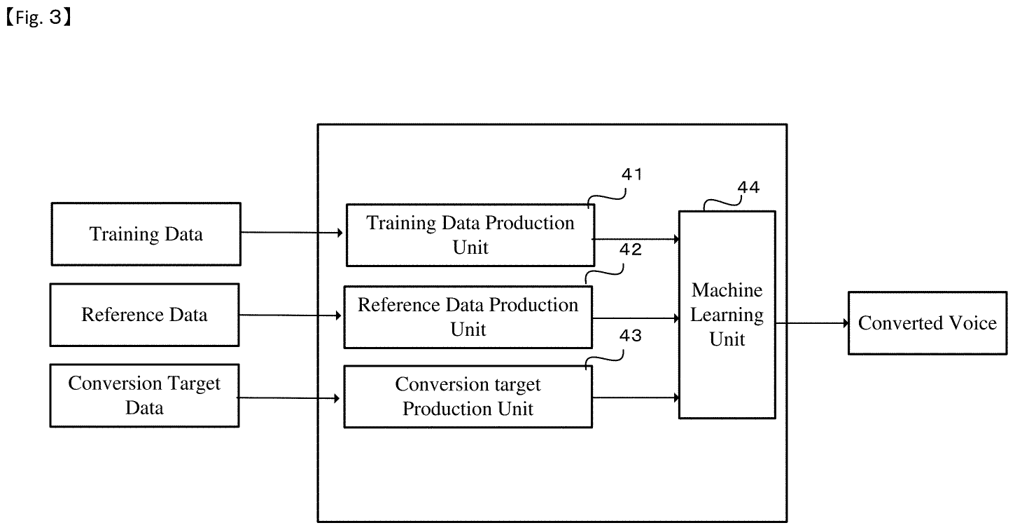

Next, an example of the functions of each of the server device 20 and the terminal device 30 will be described with reference to FIG. 3. FIG. 3 is a block diagram schematically illustrating an example of the functions of the system illustrated in FIG. 1. As illustrated in FIG. 3, the system as an example may include a training data production unit 41 that produces training data, a reference data production unit 42 that produces reference data, a conversion target data production unit 43 that produces conversion target data, and a machine learning unit 44 that has a function related to machine learning. Furthermore, the system as an example may include, for example, the reference data production unit 42, the conversion target data production unit 43, and the machine learning unit 44, and another system may include the conversion target data production unit 43 and the machine learning unit 44. As will be readily understood to a person of skill in the art having the benefit of the current disclosure, any one or more of the functional units 41, 42, 43, and 44 can be implemented using the server device 20, terminal device 30, and/or computing environment 1300 disclosed above. Further, the functional units 41, 42, 43, and 33 can be implemented with a processor executing computer-readable instructions to perform the disclosed operations. In other examples, any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), or Complex Programmable Logic Devices (CPLDs), can be used alone or with a general-purpose processor to implement the described functions.

3.1. Learning Data Acquisition Unit 41

The training data production unit 41 has a function of producing voice data to be used as training data.

There may be various modes for producing a voice. For example, the voice may be produced from a file stored in an data processing apparatus in which an production unit is mounted, or may be produced from data transmitted via a network (e.g., as a complete data file, or as a data stream that is received in real-time, via the network). In a case of the production from a file, a recording format thereof may be diverse and is not limited. For example, a voice may be produced by using a sensor to capture audio data (for example, using a microphone or other suitable sound input transducer), digitized with a processor, and stored in a suitable format in computer-readable storage media. As is understood in the art, such technology may be refereed to as an audio encoder. Examples of suitable audio file formats output by an encoder can include but are not limited to one or more of: WAV, MP3, OGG, AAC, WMA, PCM, AIFF, FLAC, or ALAC. The audio file format may be a lossy format (e.g., MP3) or a lossless format (e.g., FLAC).

For example, the training data production unit 41 may have a function of producing a first voice and a second voice. As the voice, a plurality of voices may be produced from the same person. In a case where a plurality of voices of the same person are produced and used for the machine learning unit 44 to be described later, it is possible to produce data with consistency regarding the individuality of the same person, and it is more likely that data can be produced while distinguishing language data and non-language data to be described later from each other. In particular, there is an advantage that a possibility that data can be produced while distinguishing the language data and the non-language data from each other in more various contexts and expressions is increased, in a case where the plurality of voices include various expressions in various contexts.

Note that the technology according to the disclosed technology does not target only Japanese language as the voice, and may target a language of another country. However, languages produced by the training data production unit 41, the reference data production unit 42, and the conversion target data production unit 43 are preferably the same languages. This is because it is considered that learning performed while distinguishing the language data and the non-language data to be described later from each other is different for each language.

After the voice data to be used as the training data is produced by the training data production unit 41, the machine learning unit 44 to be described later may perform machine learning by using the voice data to be used as the training data.

3.2. Reference Data Acquisition Unit 42

The reference data production unit 42 may have a function of producing a reference voice which is the reference data. The reference data may be a voice of any person, but as one usage mode, the reference data may be language used as a reference when the conversion target data to be described later is converted. For example, the person may be an entertainer, a famous person, a celebrity, a voice actor, a friend, or the like.

The reference data production unit 42 may produce the reference voice of one or more persons. The reference data production unit 42 may produce a plurality of voices for each person. As described above, in a case where the plurality of voices include various expressions in various contexts, there is a high possibility that the non-language data in the reference voice can be accurately produced. Similar components and data formats as those described above regarding the training data production unit can be used to produce the reference data.

Note that, in the above description, the reference data has been described with an example of a person, but the reference data may be a sound other than a voice of a person, the sound being generated by another method, for example, in a case where it is desired to perform conversion into a mechanical voice. In this case, there is an advantage that the conversion target data to be described later can be converted with reference to such a sound. Note that, in the present specification, a sound generated by another method, other than a voice of a person, may also be referred to as a voice for convenience. Similar components and data formats as those described above regarding the training data production unit can be used to produce the reference data.

3.3. Conversion Target Data Acquisition Unit 43

The conversion target data production unit 43 may have a function of producing input voice to be converted, which is the conversion target data. The input voice to be converted is a voice whose non-language data is desired to be converted without changing a verbal content of the voice. For example, the voice may be a voice of a user of this system.

The input voice to be converted may be a voice including various expressions, or does not have to include various expressions unlike the above-described training data and reference data, and may be a single expression. Similar components and data formats as those described above regarding the training data production unit can be used to produce the reference data.

3.4. Machine Learning Unit 44

The machine learning unit 44 has a function related to machine learning. The function related to machine learning can be a function to which a machine-learned function is applied, can be a function of performing machine learning, or can be a function of further generating data related to machine learning for some machine-learned functions.

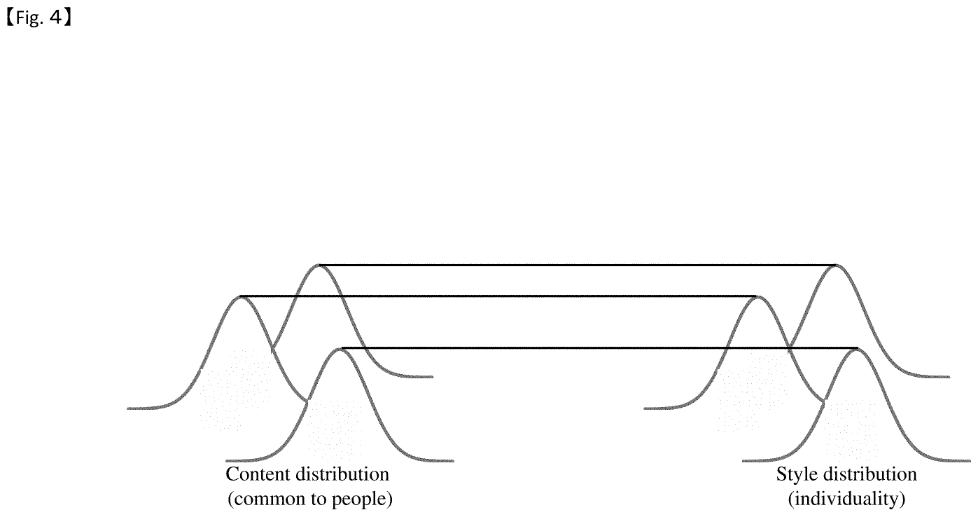

Here, a viewpoint that is a background of the disclosed technology will be described. Since humans can hear the individuality even when an utterance content is the same, it is considered that the voice has the utterance content and a component carrying the individuality. More specifically, the voice may be divided into the utterance content and the component carrying the individuality. In a case where each of the utterance content and the component carrying the individuality can be produced from the voice in this manner, conversion of a voice of a person A can be performed in such a manner that the voice of the person A sounds like it is uttered by a person B. That is, the utterance content (language data) common to people is produced from the voice of the person A. Then, the component carrying the individuality (non-language data) peculiar to the person B is produced from the person B. Then, the non-language data of the person B can be applied to the language data of the person A, thereby performing the conversion of the voice of the person A in such a manner that the voice of the person A sounds like it is uttered by the person B. FIG. 4 illustrates such a situation. The language data (which may be referred to as “content” in the present specification) is common to people, and the non-language data (which may also be referred to as “style” in the present specification), which is different for each individual, is applied to the language data. By such application, a voice similar to a desired voice of a person can be created, and thus, for example, a voice of an entertainer, a voice actor, a friend, or the like can be created.

The above viewpoint will be described more technically. The above-described conversion can be formalized as a problem of estimating the style in a state where the content has been observed. That is, modeling can be performed like P(style|content). Here, P(A|1B) may be regarded as modeling in Bayesian statistics for estimating A in a state where B has been observed, or may be regarded as modeling in maximum likelihood estimation. Specifically, such modeling assumes that the simultaneous probability density function (PDF) of the content and the style follows a mixed Gaussian distribution, as illustrated in FIG. 4. As described above, such a process embodies a process in which a specific voice includes a distribution based on the language data common to people and a distribution based on the non-language data indicating the individuality of a person who has uttered the voice.

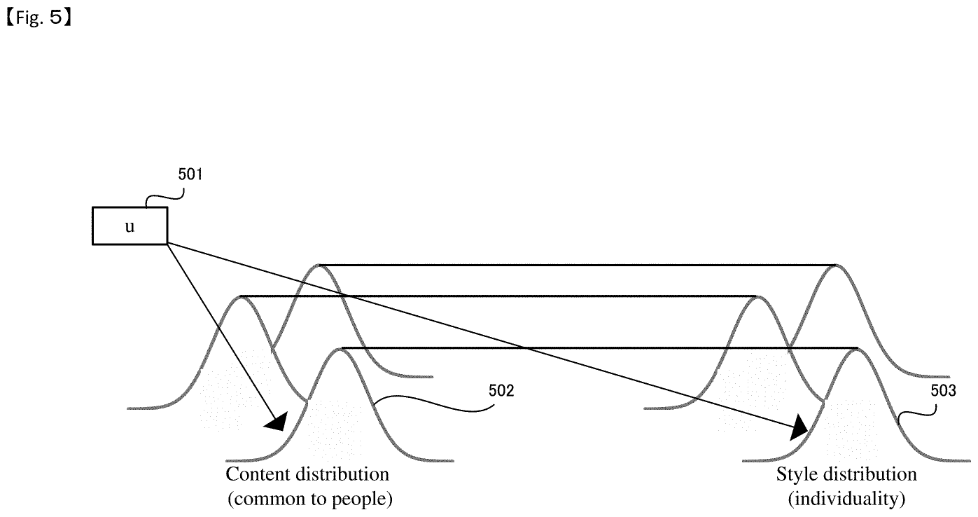

Then, it is considered that, when each of the language data and the non-language data can be extracted from the voice as described above, for example, as illustrated in FIG. 5, the content (language data) and the style (non-language data) are produced from a voice of a specific person, so that data indicating the individuality of the specific person (data capable of expressing the non-language data) can be produced because the content is already known. In FIG. 5, specifically, in a case where the voice is a word “u” 501, since “u” 502 as the language data is known, the non-language data in the voice uttering “u” can be specified as non-language data 503 related to “u” for a person who has uttered the voice, and thus a parameter in the non-language data can be produced. As described above, in a case where the language data and the non-language data can be extracted from the voice, the non-language data corresponding to various voices of a specific person can be produced from the voice of the specific person.

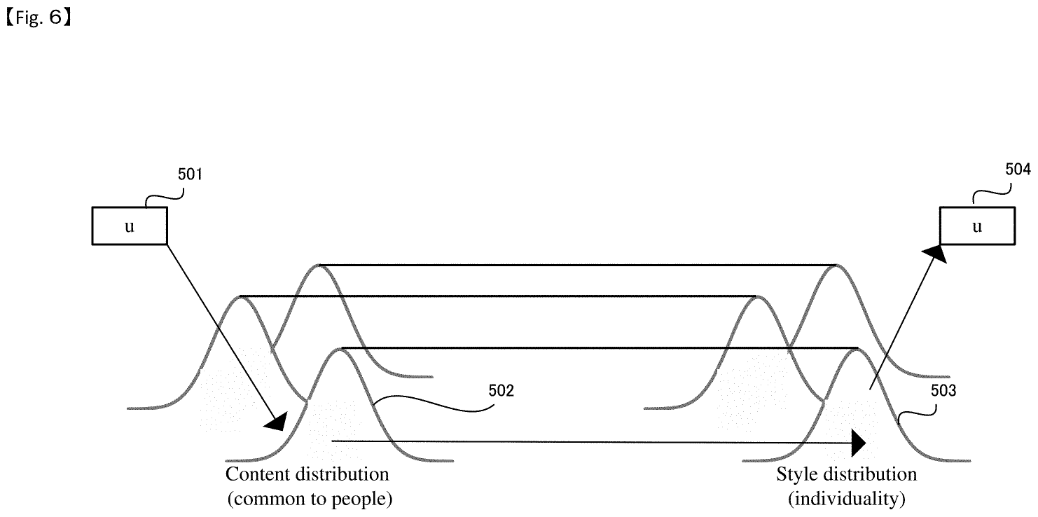

Next, the language data is produced from the voice, and the data indicating the individuality of the specific person (the parameter in the non-language data) is used, so that the language data can be converted into a voice using the data indicating the individuality. Specifically, as illustrated in FIG. 6, in a case where the voice “u” 501 is produced, the language data and the non-language data are produced, and the language data is found to be “u” 502 of a content distribution, “u” 503 of a style distribution of a specific person is found in association therewith, and a voice “u” 504 of the specific person can be generated based on the association.

Hereinafter, the machine learning unit 44 that performs such inference functions will be specifically described. Note that each of the following expressions represent operations that can be performed by executing a collection of computer-readable instructions (a program) by a computer. In addition, each expression may represent not only each program module but also a program module in which relative program modules are integrated into an application.

The machine learning unit 44 may include one or more encoders. The machine learning unit 44 may have a function of adjusting a weight related to the encoder by using the voice data used as the training data and produced by the training data production unit 41. For example, the machine learning unit 44 may have a function of adjusting a weight related to a first encoder and a weight related to a second encoder so as to decrease a reconstruction error between a first voice and a generated first voice to be smaller than a predetermined value. Here, the generated first voice may be generated by using first language data produced from the first voice by using the first encoder, second language data produced from a second voice by using the first encoder, and second non-language data produced from the second voice by using the second encoder, and the machine learning unit 44 may have a function of generating such data.

Here, the machine learning unit 44 can implement the function of adjusting the reconstruction error may be a loss function in a machine learning algorithm. Loss functions of various aspects may be used as the loss function. Furthermore, the loss function may be a loss function according to a characteristic of training data. For example, the loss function may be a loss function based on parallel training data or non-parallel training data.

The parallel training data may be based on dynamic time warping (DTW). Here, a soft DTW loss function may be applied. An example of some suitable DTW techniques are described in: “Soft-dtw: a differentiable loss function for time-series” in ICML, 2017 by M. Cututri and M. Blondel. The use of the machine learning technology of the present disclosure enables association between an output and a correct answer data instead of association between an input and the correct answer data as in a normal DTW-based approach, which has an advantage that a mismatch of association of training phrases can be suppressed.

For the non-parallel training data, the loss function may be designed linearly. For example, a frame-wise mean squared error may be used. Examples of suitable loss functions include those described in “Zero-shot voice style transfer with only autoencoder loss” ICML, 2019 by K. Qian, Y. Zhang, S. Chang, X. Yang, and M. Hasegawa Johnson, and the like.

Here, one-shot voice conversion according to the disclosed technology is formulated. First, the following is a sequence of input features.

x={x(t)}_{t≤1}^{T}^{ₓ}

The following is a sequence of reference features.

r={r(t)}_{t≤1}^{T}^{ᵣ}

The following is a sequence of converted (generated) features.

\hat{x}={\hat{x}(t)}_{t≤1}^{T}^{ₓ}

Note that, in the present specification, the feature may be the voice. In addition, the alphabet may indicate a sequence of vectors, and (t) is an index of time unless otherwise specified. A relationship between these sequences is defined as follows.

\hat{x}=f(x, r; θ)

Here, f is a conversion function parameterized by θ. Parameter optimization is described as follows for a given dataset X.

$${minimize}_{θ} {\sum }_{x , r , y ∈ X} ℒ ( y , f ( x , r ; θ ) )$$

Here, the following function (1) is a loss function that measures a closeness between y and the following (2), and for example, a stochastic gradient descent method or the like may be applied to such a process.

[symbol]

(y, \hat{x}) (1)

\hat{x} (2)

On the premise of the above formulation, the above-described loss function may be defined as follows, for example.

$$ℒ ( y , \hat{x} ) = \{ \begin{matrix}{λ}_{MSE} {ℒ}_{MSE} ( y , \hat{x} ) & ( y = x ) \\ {λ}_{DTW} {ℒ}_{DTW} ( y , \hat{x} ; γ ) & ( otherwise )\end{matrix} \\ {ℒ}_{MSE} ( y , \hat{x} ) = \frac{1}{MT} {\sum }_{t = 1}^{T} {‖ y ( t ) - \hat{x} ( t ) ‖}_{2}^{2} \\ {ℒ}_{DTW} ( y , \hat{x} , γ ) = \frac{1}{MT} {dtw}_{γ} ( y , \hat{x} ) ,$$

Here, y may be the same as x, and r may be the same speaker as x. In addition, λ_{MSE} and λ_{DTW} are hyperparameters for weight balance. In addition, the following applies.

M=dim \hat{x}(t)

Note that T is a length of the following sequence.

\hat{x}

The above-described first encoder may be an encoder capable of producing the language data from the voice by machine learning performed by the machine learning unit 44. Examples of the language data include Japanese such as “Konnichiwa” and English language expressions.

Furthermore, the above-described second encoder may be an encoder capable of producing the non-language data from the voice by machine learning performed by the machine learning unit 44. The non-language data may be data other than the language data, and may include a sound quality, an intonation, a pitch of the voice, and the like.

The machine learning unit 44 before machine learning may include such an encoder before machine learning, and the machine learning unit 44 after machine learning may include an encoder whose weighting is adjusted after machine learning.

Note that, in the present specification, the encoder converts the voice into data processible in the machine learning unit 44, and a decoder has a function of converting the data processible in the machine learning unit 44 into the voice. More specifically, as described above, the first encoder may convert the voice into the language data, and the second encoder may convert the voice into the non-language data. Furthermore, the decoder may produce the language data and the non-language data and convert the language data and the non-language data into the voice. Note that since the language data and the non-language data are data processible in the machine learning unit 44, the language data and the non-language data may have various data modes. For example, the data may be a number, a vector, or the like.

Here, two models will be exemplified for a relationship between the encoder and the decoder described above. In the technology according to the disclosed technology, these models may be implemented.

A first model is a multiscale autoencoder. As described above, a plurality of encoders Ec(x) and Es(r) may be applied to the language data and the non-language data, respectively. Here, Ec(x) corresponds to the first encoder described above, and Es(r) corresponds to the second encoder described above. The encoder and the decoder may have the following relationship.

w⁽¹⁾, . . . , w^{(L)}=E_{c}(x)

z⁽¹⁾, . . . , z^{(L)}=Eₛ(r)

\hat{x}=D({w^{(l)}}ₗ₌₁^{L}, {z^{(l)}}ₗ₌₁^{L})

Here, the following two are multiscale features extracted from x and r, respectively.

{w^{(l)}}ₗ₌₁^{L}

{z^{(l)}}ₗ₌₁^{L}

A second model is an attention-based speaker embedding. In the one-shot voice conversion, the non-language data may appear in a mode depending on the language data. That is, there are specific vowel sound dependent data and specific consonant sound dependent data. For example, in a case where a vowel sound is combined, a vowel sound region in reference data is regarded as being more important than other regions such as a consonant sound portion and a silence portion. In other words, the non-language data in a specific voice may depend on the language data in the specific voice. For example, the amount of non-language data of a vowel sound for specific first language data may be larger than the amount of non-language data of a consonant sound and a silence for the specific first language data in the non-language data, but the amount of non-language data of a vowel sound for specific second language data may be smaller than the amount of non-language data of a consonant sound and a silence for the specific second language data in the non-language data. Such processing can be efficiently performed by using softmax mapping in an attention mechanism. For example, such processing may be implemented by a decoder D defined as follows.

c^{(l)}, q^{(l)}=split(w^{(l)})

k^{(l)}, v^{(l)}=split(z^{(l)})

s^{(l)}=Attention(q^{(l)}, k^{(l)}, v^{(l)})

\hat{x}=\hat{D}(c⁽¹⁾, . . . , c^{(L)}, s⁽¹⁾, . . . , s^{(L)})

Intuitively, this is processing in which the decoder attempts to generate the following voice features by using language data c₍₁₎ and non-language data s₍₁₎ dependent on the language data.

\hat{x}

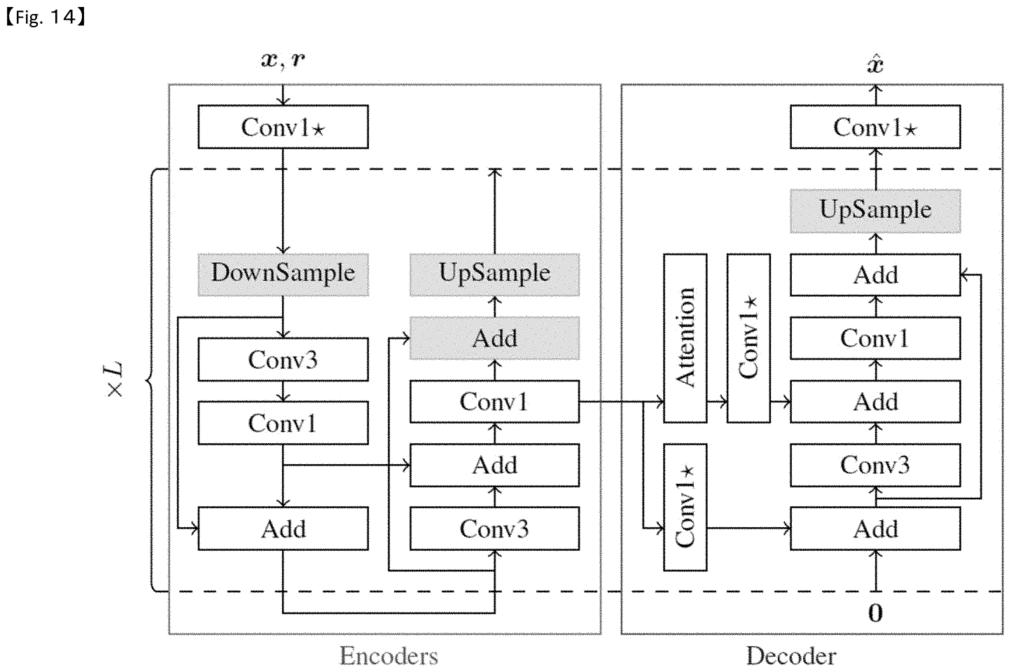

FIG. 14 illustrates an example of configurations of the encoder and the decoder described above. FIG. 14 illustrates an architecture of a convolutional neural network. Conv{k} indicates one-dimensional convolution of a kernel size k. Each convolution layer is followed by Gaussian error linear unit (GELU) activation, except those indicated by ★. UpSample, DownSample, and Add that are shaded may not be used in a shallow iteration. The two encoders may have the same structure.

Furthermore, although an example in which processing is performed on a voice by using a spectrogram obtained by frequency-resolving a sound has been described above, but the disclosed technology is not limited thereto.

Furthermore, the machine learning unit 44 may generate the above-described generated first voice by various methods. For example, the generated first voice may be generated by using a second parameter μ₂ generated by applying the second language data and the second non-language data to a first predetermined function. Here, the first predetermined function may be, for example, a Gaussian mixture model. This is because an establishment model is suitable for expressing a signal including fluctuation, such as a voice, and there are advantages that analytic handling becomes easy by using a mixed Gaussian portion, and a multimodal complicated probability distribution such as a voice can be expressed. Note that the generated second parameter μ₂ may be, for example, a number, a vector, or the like.

Specifically, a function based on the following expression may be used as the Gaussian mixture model.

B(K₂, S₂)=μ₂ Expression (1)

Here, E₁(X₂)=K₂ and E₂(X₂)=S₂. E₁ represents the first encoder as a function, and E₂ represents the second encoder as a function. That is, the former expression means that the first encoder receives the second voice and generates the second language data K₂, and the latter expression means that the second encoder receives the second voice and generates the second non-language data S₂. Note that, in the following, for the sake of explanation, the description will be provided based on the above-described simple expression, but a detailed expression of an example will be described below just in case.

In the following expression, it is assumed that kₜ and sₜ are K and S for each time, and wᵢ is a weight of a Gaussian component and satisfies Σᵢwᵢ=1. In addition, μ_{k,i} and Σ_{k,i} are each an average vector/variance matrix for each Gaussian component of the mixed Gaussian on the component side. Furthermore, μ_{s,i} and Σ_{s,i} are each an average vector/variance matrix for each Gaussian component of the mixed Gaussian on the style side.

$$μ : = \{ {w}_{i} , {μ}_{k , i} , {Σ}_{k , i} , {μ}_{s , i} , {Σ}_{s , i} \}$$

$$μ = B ( K , S ) = {arg max}_{μ} likelihood ( K , S ; μ )$$

$$likelihood ( K , S ; μ ) = {\sum }_{t} log {\sum }_{i} {w}_{i} N ( {k}_{t} ; {μ}_{k , i} , {Σ}_{k , i} ) N ( {s}_{t} ; {μ}_{s , i} , {Σ}_{s , i} )$$

$$N ( {x}_{t} ; {μ}_{j} , {Σ}_{j} ) = \frac{1}{\sqrt{{( 2 π )}^{d} \vert {Σ}_{j} \vert}} exp ( - \frac{1}{2} {( {x}_{t} - {μ}_{j} )}^{T} {Σ}_{j}^{- 1} ( {x}_{t} - {μ}_{j} ) )$$

Note that d is a dimension of xₜ, and an EM algorithm or another general numerical optimization technique may be able to be applied as a method of computing argmax.

The generated first voice may be generated by using first generated non-language data S′₂ generated by applying the first language data K₁ and the second parameter μ₂ to a second predetermined function A. More specifically, the first generated non-language data S′₂ may be able to be generated by applying the first language data K₁ and the second parameter μ₂ to the second predetermined function A. Here, the generated non-language data S′₂ may be generated by the function A and may be an input to the decoder to be described later. Here, as the second predetermined function A, for example, the following expression may be established.

A(K₁, μ₂)=S′₂

Hereinafter, a description will be provided using the above-described simple function A. However, just in case, an example of a detailed description will be given below.

S₂′=A(K₁,μ₂)=E_{likelihood(K}_{₁}_{,S}_{₂}_{:μ}_{₂}₎[S₂|K₁]

Here, E_{likelihood(K1,S2;μ2)} [S₂|K₁] represents an expectation value regarding the probability density of S₂ when K₁ is given. The expectation value may be obtained analytically because the likelihood function is independent at each time.

$${s}_{t}^{′} = \frac{{Σ}_{i} {w}_{i} N ( {k}_{t} , {μ}_{k , i} , {Σ}_{k , i} ) {μ}_{s , i}}{{Σ}_{i} {w}_{i} N ( {k}_{t} , {μ}_{k , i} , {Σ}_{k , i} )}$$

Note that the second predetermined function A may calculate a variance of the second parameter μ₂ or may calculate a covariance of the second parameter μ₂. In the latter case, there is an advantage that data of the second parameter μ₂ can be further used unlike the former case.

The generated first voice may be generated by applying the first language data and the first generated non-language data to the decoder. Here, the following relationship is established as a function D of the decoder.

D(K₁, S′₂)=X′₁

Here, K₁ is generated as E₁(X₁)=K₁, and is the first language data, and the generated non-language data S′₂ is generated by the second predetermined function. X′₁ is the generated first voice generated using the first predetermined function, the second predetermined function, and the decoder by the above-described processing.

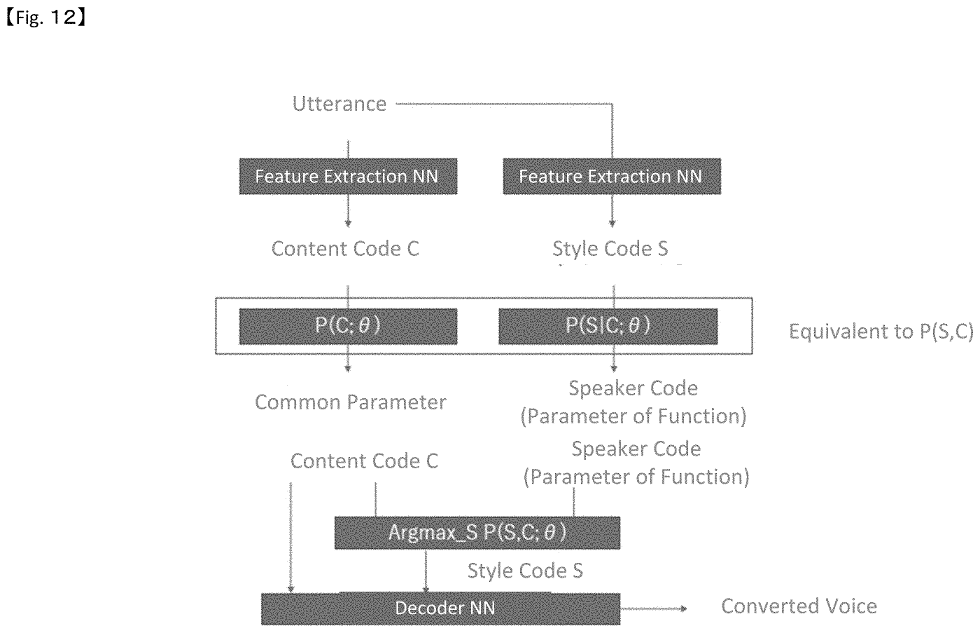

The generated first voice is preferably the same as the original first voice. A case where the first voice and the generated first voice are the same is described as the following situation. That is, the first encoder and the second encoder generate a first language voice and a first non-language voice, respectively, from the produced first voice. Among these, the fact that the decoder generates the generated first voice by applying the first language data and generated first non-language data means that the generated first non-language data can be reproduced using the non-language data included in another voice without using the first non-language data. FIG. 12 is an example illustrating the above-described relationship.

The reconstruction error between the first voice and the generated first voice should be generated as to be smaller than a predetermined value by adjusting weighting related to the first encoder, the second encoder, the first predetermined function, the second predetermined function, and the decoder as described above.

The machine learning unit 44 according to an embodiment may have functions of: producing the first language data from the first voice by using the first encoder; producing the second language data from the second voice by using the first encoder; producing the second non-language data from the second voice by using the second encoder; generating the reconstruction error between the first voice and the generated first voice generated by using the first language data, the second language data, and the second non-language data; and adjusting a weight related to the first encoder and a weight related to the second encoder.

The first encoder, the second encoder, the first predetermined function, the second predetermined function, and the decoder may use deep learning in an artificial neural network. However, as described above, the first encoder and the second encoder each produce the language data and the non-language data for the voice, and the first predetermined function may generate the parameter μ₂ by using the language data and the non-language data of the same person.

Note that the function B may be a function in which a plurality of arguments are further input, and may be, for example, the following function.

B(K₂, S₂, K₃, S₃, K₄, S₄, . . . )=μ₂ Expression (1)′

More specifically, here, K₃, S₃, K₄, and S₄ are generated as E₁(X₃)=K₃, E₂(X₃)=S₃, E₁(X₄)=K₄, and E₂(X₄)=S₄, respectively. Assuming that X₃ is a third voice and X₄ is a fourth voice, third language data, third non-language data, fourth language data, and fourth non-language data are generated by applying the first encoder E₁ and the second encoder E₂ to each of the third voice and the fourth voice.

That is, the first encoder may function to produce the third language data from the third voice, the second encoder may function to produce the third non-language data from the third voice, and the first predetermined function may function to generate the second parameter μ₂ by further using the third language data and the third non-language data. Here, the first predetermined function may be the function B as described above. As described above, as the function B generates the language data and the non-language data corresponding to each of a plurality of voices by using each of the first encoder and the second encoder, and generates the second parameter μ₂ based on the language data and the non-language data, there is an advantage that it is possible to generate the first encoder and the second encoder capable of decomposing the language data and the non-language data in the relationship with the function B and the second predetermined function for a larger number of voices, and the decoder capable of performing reconstruction with less reconstruction error. In other words, there is an advantage that it is possible to generate the encoder, the decoder, the function B, and the second predetermined function that enable decomposition of the language data and the non-language data and reconstruction for various voices.

In particular, in a case where the language data and the non-language data are based on a voice of the same person, they share a certain common feature or tendency. Therefore, in a case where weighting related to the encoder that decomposes the language data and the non-language data and the decoder that performs reconstruction is adjusted by the neural network using deep learning for the voice of the same person, more consistent weighting adjustment can be performed, which is advantageous. That is, the second voice and the third voice may be voices of the same person.

This point will be described using an example. For example, it is assumed that there are N (N is an integer) persons P₁ to P_{N} as persons who utter voices to be used as the training data. In addition, since there are a plurality of voices for each person, for example, it is assumed that there are P₁X₁ to P₁Xₘ as voices 1 to m (m is an integer) of the person P₁. Similarly, it is assumed that there are P₂X₁ to P₂Xₘ as voices 1 to m of the person P₂.

First, when learning the voices of the person P1, learning is performed for P₁X₁ to P₁Xₘ. Specifically, the weighting related to the first encoder, the second encoder, the function B, the function A, and the decoder is adjusted by the following expression. First, learning is performed for the person P1 as follows.

$${E}_{1} ( {P}_{1} {X}_{1} ) = {K}_{1} \\ {E}_{1} ( {P}_{1} {X}_{2} ) = {K}_{2} \\ {E}_{2} ( {P}_{1} {X}_{2} ) = {S}_{2} \\ {E}_{1} ( {P}_{1} {X}_{3} ) = {K}_{3} \\ {E}_{2} ( {P}_{1} {X}_{3} ) = {S}_{3}$$

$$…$$

$${E}_{1} ( {P}_{1} {X}_{m} ) = {K}_{m}$$

$${E}_{2} ( {P}_{1} {X}_{m} ) = {S}_{m}$$

Next, the functions B, A, and D are applied as follows.

B(K₂, S₂, K₃, S₃, . . . , Kₘ, Sₘ)=μ₂

A(K₁, μ₂)=S′₂

D(K₁, S′₂)=P₁X′₁

The weighting is adjusted in such a manner that a reconstruction error between a generated first voice P₁X′₁ and the originally produced voice P₁X₁ is a predetermined value or less. Note that, as described above, as the voice of the same person P₁ is used, it is possible to distinguish the language data and the non-language data unique to the person, which are the inputs of the function B.

Next, the same applies to the person P₂. That is, the following functions are applied.

$${E}_{1} ( {P}_{2} {X}_{1} ) = {K}_{1} \\ {E}_{1} ( {P}_{2} {X}_{2} ) = {K}_{2} \\ {E}_{2} ( {P}_{2} {X}_{2} ) = {S}_{2} \\ {E}_{1} ( {P}_{2} {X}_{3} ) = {K}_{3} \\ {E}_{2} ( {P}_{2} {X}_{3} ) = {S}_{3}$$

$$…$$

$${E}_{1} ( {P}_{2} {X}_{m} ) = {K}_{m}$$

$${E}_{2} ( {P}_{2} {X}_{m} ) = {S}_{m}$$

Next, the functions B, A, and D are applied as follows.

B(K₂, S₂, K₃, S₃, . . . , Kₘ, Sₘ)=μ₂

A(K₁, μ₂)=S′₂

D(K₁, S′₂)=P₂X′₁

The weighting is adjusted in such a manner that a reconstruction error between the generated first voice P₂X′₁ and the originally produced voice P₂X₁ is a predetermined value or less.

In this manner, the processing is similarly performed up to P_{N}. Furthermore, the processing may be performed on other voices of P₁. That is,

$${E}_{1} ( {P}_{1} {X}_{2} ) = {K}_{2}$$

$${E}_{1} ( {P}_{1} {X}_{1} ) = {K}_{1}$$

$${E}_{2} ( {P}_{1} {X}_{1} ) = {S}_{1}$$

$${E}_{1} ( {P}_{1} {X}_{3} ) = {K}_{3}$$

$${E}_{2} ( {P}_{1} {X}_{3} ) = {S}_{3}$$

$$…$$

$${E}_{1} ( {P}_{1} {X}_{m} ) = {K}_{m}$$

$${E}_{2} ( {P}_{1} {X}_{m} ) = {S}_{m}$$

Next, the functions B, A, and D are applied as follows.

B(K₂, S₂, K₃, S₃, . . . , Kₘ, Sₘ)=μ₂

A(K₂, μ₂)=S′₂

D(K₂, S′₂)=P₁X′₂

The weighting is adjusted in such a manner that a reconstruction error between a generated first voice P₁X′₂ and the originally produced voice P₁X₂ is a predetermined value or less. Similarly, machine learning may be performed on each of other voices P₁X′₃ to P₁X′ₘ of P₁ or a part thereof. As described above, there is an advantage that the training data can be effectively used by application to the person P₁ and another voice P₁X₂.

In this way, as machine learning is performed on the voices X₁ to Xₘ of each of the persons P₁ to P_{N}, there is an advantage that the language data and the non-language data can be stably and accurately divided for various people, and only the non-language data can be applied to other people.

Note that, since the second encoder configured as described above generates the non-language data corresponding to each voice, the non-language data depends on time data of the voice. Furthermore, each piece of non-language data may depend on each piece of language data of the voice. Therefore, the non-language data is not uniformly applied to the voice of the speaker, but each piece of non-language data can be generated for each voice even in a case where the respective voices are voices of the same person. Then, in the system of the present embodiment, the weighting is adjusted in such a manner that each piece of non-language data can be generated for each voice. Therefore, instead of applying uniform non-language data to the same person, the non-language data can be generated corresponding to various voices of the same person. As a result, a voice similar to the reference voice can be generated more finely, which is advantageous. Note that this means that the weighting related to each of the first encoder, the second encoder, the first predetermined function, the second predetermined function, and the decoder acts using the time data of the voice or data of each voice (for example, the language data in the voice).

Furthermore, the machine learning unit 44 may adjust the weight related to the first encoder, the weight related to the second encoder, a weight related to the first predetermined function, a weight related to the second predetermined function, and a weight related to the decoder by back propagation by deep learning. In particular, the weight related to the first encoder, the weight related to the second encoder, and the weight related to the decoder may be adjusted by back propagation.

In addition, the machine learning unit 44 may generate data based on the reference voice from the reference voice, which is the reference data produced by the reference data production unit 42. Here, the data based on the reference voice may include a reference parameter μ₃. That is, for the produced reference voice, the machine learning unit 44 may have a function of generating reference language data by applying the produced reference voice to the first encoder, generating reference non-language data by applying the reference voice to the second encoder, and generating the reference parameter μ₃ by applying the reference language data and the reference non-language data to the first predetermined function. Further, the reference parameter μ₃ may be generated by applying, to the first predetermined function, the reference language data generated by applying the reference voice to the first encoder and the reference non-language data generated by applying the reference voice to the second encoder.

In this regard, more specifically, for the produced reference voice X₃, the third language data may be generated by applying the produced reference voice X₃ to the first encoder like E₁(X₃)=K₃, the third non-language data may be generated by applying the reference voice X₃ to the second encoder like E₂(X₃)=S₃, and the reference parameter μ₃ based on the reference voice may be generated like B(K₃, S₃)=μ₃. Note that the generated reference parameter μ₃ may be, for example, a number, a vector, or the like. Note that, here, the reference parameter μ₃ may be generated by using E₁, E₂, and B (first predetermined function) after adjustment of the weighting by machine learning for the above-described voice.

The machine learning unit 44 may have a function of converting the input voice to be converted, which is the conversion target data produced by the conversion target data production unit 43, and generating a converted voice. For example, the machine learning unit 44 may have a function of applying the first encoder to the produced input voice to be converted to generate language data of input voice, applying the language data of input voice and the reference parameter μ₃ to the second predetermined function to generate input voice non-language data, and applying the decoder to the language data of input voice and the input voice non-language data to generate the converted voice. Note that, here, the converted voice may be generated by using the first encoder, the second predetermined function (A), and the decoder after adjustment of the weighting by machine learning for the above-described voice.

In addition, the machine learning unit 44 may have a function of converting the input voice to be converted and generating the converted voice similarly for one reference voice selected from a plurality of reference voices. For example, the machine learning unit 44 may have a function of producing one option selected from a plurality of options of voices and the input voice to be converted, applying the first encoder to the input voice to be converted to generate the language data of input voice, applying the language data of input voice and a reference parameter μ related to the selected one option to the second predetermined function to generate input voice generated non-language data, and applying the decoder to the language data of input voice and the input voice generated non-language data to generate the converted voice

Furthermore, the machine learning unit 44 may be implemented by a trained machine learning model. The trained machine learning model can be used as a program module that is a part of an artificial intelligence software application. As described above, the trained machine learning model of the disclosed technology may be used in a computer including a CPU and a memory. Specifically, the CPU of the computer may be operated in accordance with a command from the trained machine learning model stored in the memory.

4. Flow of Data Processing in System According to Example Embodiments

4-1. Embodiment 1

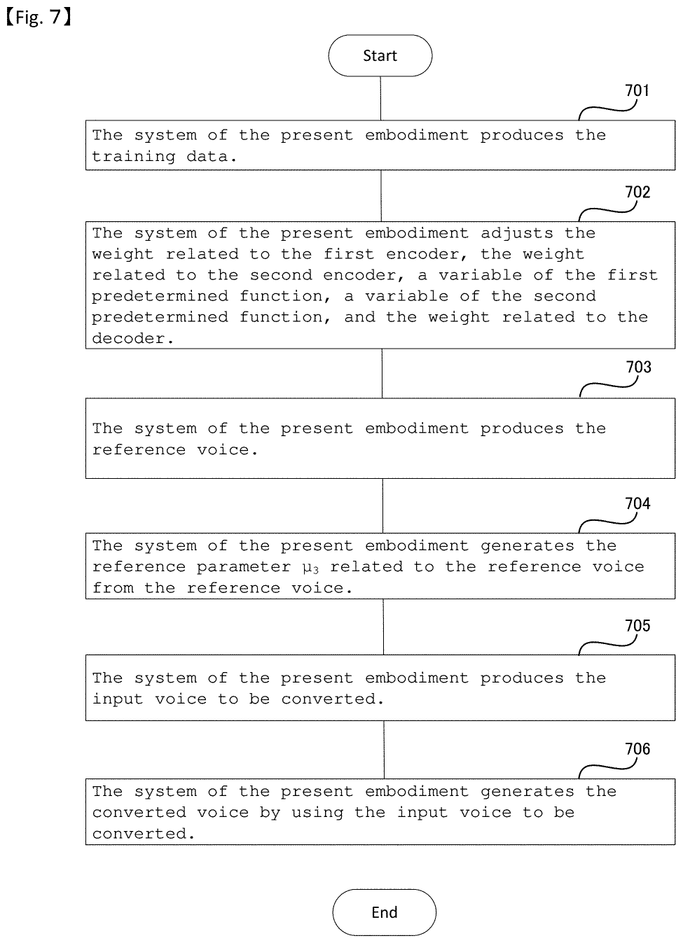

Next, a system according to Embodiment 1, which is an aspect of the disclosed technology, will be described. The system according to the present embodiment is an example including a configuration for performing machine learning. This will be described with reference to FIG. 7.

Step 1

The system of the present embodiment produces the training data (701). Here, the training data may be voices of a plurality of persons. As the voices of the plurality of persons are produced and used in the following, there is an advantage that more universal classification of the language data and the non-language data can be made.

Step 2

The system of the present embodiment adjusts the weight related to the first encoder, the weight related to the second encoder, a variable of the first predetermined function, a variable of the second predetermined function, and the weight related to the decoder (702). As described above, the weighting adjustment may be performed in such a manner that the reconstruction error between the first voice related to the training data and the generated first voice generated using a voice related to the training data other than the first voice is smaller than a predetermined value.

Step 3

The system of the present embodiment produces the reference voice (703). The reference voice may be, for example, a voice of a person having a sound quality desired by the user, such as a voice of an entertainer, a voice of a voice actor, or a voice of a celebrity.

Step 4

The system of the present embodiment generates the reference parameter μ₃ related to the reference voice from the reference voice (704).

Step 5

The system of the present embodiment produces the input voice to be converted (705). The input voice to be converted may be a voice desired by the user of the system.

Step 6

The system of the present embodiment generates the converted voice by using the input voice to be converted (706).

In the above description, voices of various persons are used as the training data. Therefore, decomposition and combination of the language data and the non-language data such as the encoder, the first predetermined function, the second predetermined function, and the decoder are possible for voices of various people. Therefore, there is an advantage that the decomposition of the language data and the non-language data for the reference voice and the conversion of the voice of the user can be applied to voices of more various people.

4-2. Embodiment 2

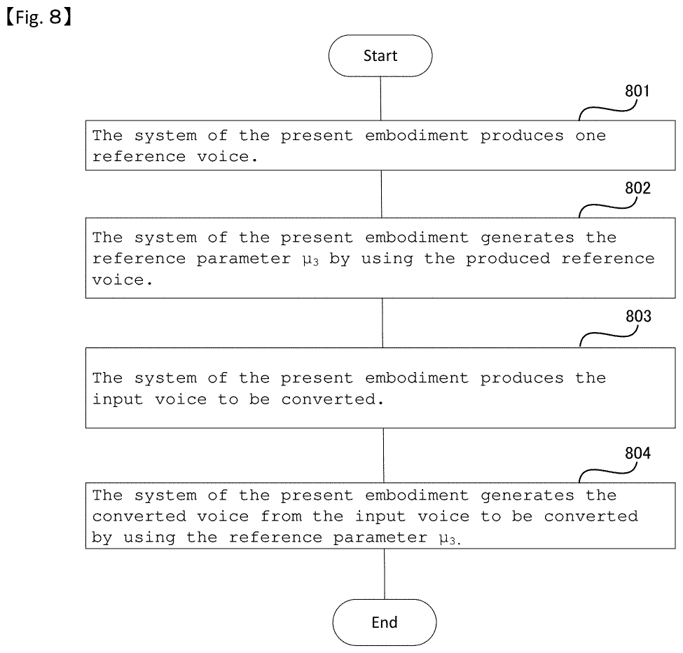

A system according to Embodiment 2 is an example having a trained machine learning function. Furthermore, the system according to the present embodiment is an example in which a conversion function is created based on the reference voice. This will be described with reference to FIG. 8.

Step 1

The system of the present embodiment produces one reference voice (801). Here, since the system of the present embodiment has been trained, the weights related to the first encoder and the second encoder capable of producing the language data and the non-language data from the voice may be already adjusted.

Step 2

The system of the present embodiment generates the reference parameter μ₃ by using the produced reference voice (802).

Step 3

The system of the present embodiment produces the input voice to be converted (803).

Step 4

The system of the present embodiment generates the converted voice from the input voice to be converted by using the reference parameter μ₃ (804). In a case where the system of the present embodiment has such a configuration, for example, in a case where the user or the like of the system desires to change his/her voice to a voice that sounds like it is uttered by another person, as the system is used, the voice uttered by the user can be converted into a voice that sounds like it is uttered by a speaker of the reference voice while the language data is the same, which is advantageous. Furthermore, there is an advantage that preliminary learning is unnecessary for the reference voice.

In addition, the system of the present embodiment may have a call function capable of transmitting the converted voice to a third party. In this case, there is an advantage that the voice of the user can be converted as described above, the converted voice can be transmitted to the other party of the call, and the third party will perceive that the speaker of the reference voice is speaking instead of the user. Note that the call function may be an analog type or a digital type. In addition, a type capable of performing transmission on the Internet may be used.

4-3. Embodiment 3

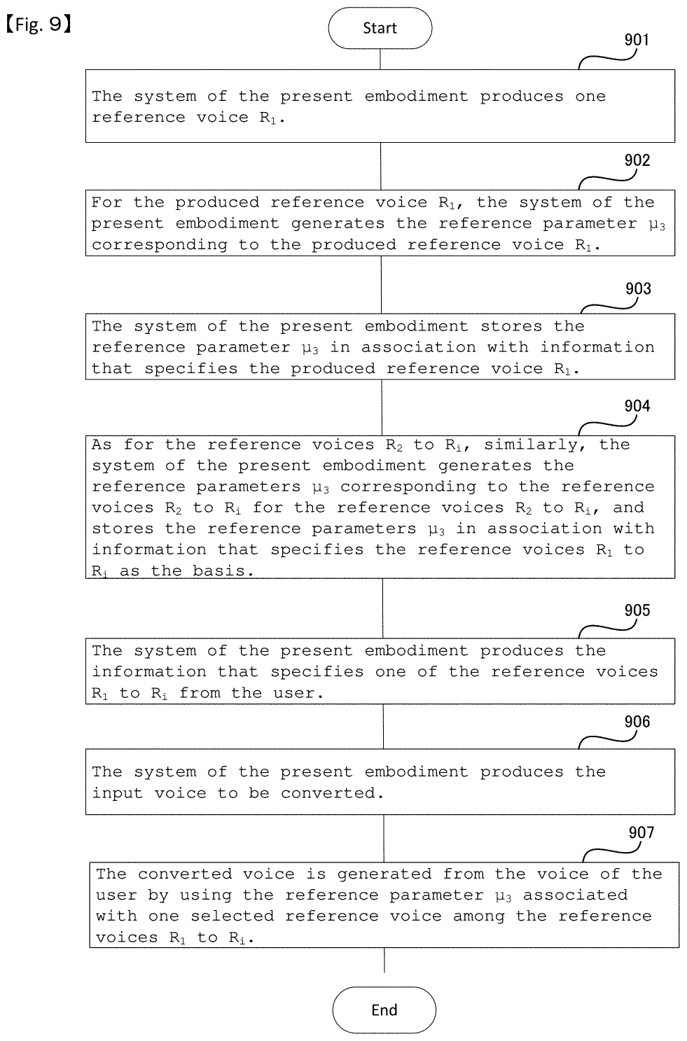

A system according to Embodiment 3 is an example in which the machine learning unit 44 subjected to machine learning is provided, a plurality of reference voices are produced, and the conversion function is created. This will be described with reference to FIG. 9.

Step 1

The system of the present embodiment produces one reference voice R₁ (901).

Step 2

For the produced reference voice R₁, the system of the present embodiment generates the reference parameter μ₃ corresponding to the produced reference voice R₁ (902).

Step 3

The system of the present embodiment stores the reference parameter μ₃ in association with data that specifies the produced reference voice R₁ (903).

Step 4

As for the reference voices R₂ to R₁, similarly, the system of the present embodiment generates the reference parameters μ₃ corresponding to the reference voices R₂ to Rᵢ for the reference voices R₂ to Rᵢ, and stores the reference parameters μ₃ in association with data that specifies the reference voices R₁ to Rᵢ as the basis (904). Note that the reference parameters μ₃ corresponding to the reference voices R₁ to Rᵢ may be different from each other.

Step 5

The system of the present embodiment produces the data that specifies one of the reference voices R₁ to Rᵢ from the user (905).

Step 6

The system of the present embodiment produces the input voice to be converted (906).

Step 7

The converted voice is generated from the voice of the user by using the reference parameter μ₃ associated with one selected reference voice among the reference voices R₁ to Rᵢ (907). With such a configuration, there is an advantage that the user of the system can select one reference voice from the plurality of prepared reference voices.

Note that, although the system of the above-described embodiment produces all the reference voices R₁ to Rᵢ and generates the reference parameters μ₃ associated with the reference voices R₁ to Rᵢ, the system of the present embodiment may have the reference parameter μ₃ associated with each of some of the reference voices R₁ to Rᵢ , for example, the reference voices R₁ to Rⱼ (j<i), for the some reference voices (R₁ to Rⱼ) at Step 1.

Furthermore, the reference parameter μ₃ for each of the some reference voices described above may have a function Aμ₂ computed by applying the reference parameter μ₃ to the function A, or a function AE₁μ₂ computed by applying the reference parameter μ₃ to the function A and the first encoder E₁. In the former case, E₁(x) obtained by applying E₁ to the voice X of the user is applied to the function Aμ₂, so that the voice X of the user may be able to be converted into a voice using the non-language data of the reference voice. Similarly, in the latter case, the function AE₁μ₂ is applied to the voice X of the user, so that the voice X of the user may be able to be converted into a voice using the non-language data of the reference voice. In other words, the function Aμ₂ may be a program (program module) generated as a result of partial computation of the function A with respect to the parameter μ₂, and the function AE₁μ₂ may be a program (program module) generated as a result of partial computation of the function A, the function E₁, and the parameter μ₂.

Furthermore, the reference voices R₁ to Rᵢ described above may be files downloaded from a server on the Internet, or may be files produced from another storage medium.

4-4. Embodiment 4

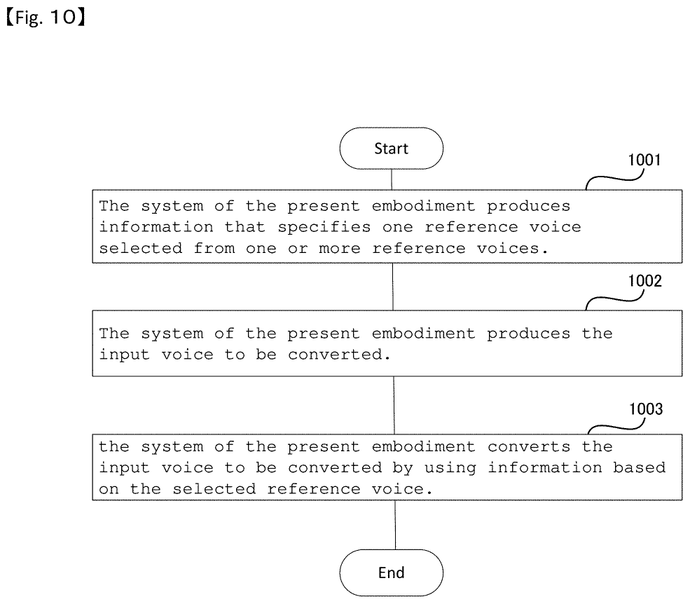

A system according to Embodiment 4 is an example of a system having a function of performing conversion into one or more reference voices by using the trained machine learning unit 44 to generate the above-described reference parameters μ₃ for each of one or more reference voices and using data based on the one or more reference voices. In the system of the present embodiment, among the functions of the machine learning unit 44, functions based on the first encoder, the decoder, and the function A are necessary, but the second encoder and the function B may or do not have to be included. Note that the functions based on the first encoder, the decoder, and the function A may be functions in which the first encoder, the decoder, and the function A themselves are programmed, or functions in which the first encoder, the decoder, and the function A are combined and programmed. This will be described below with reference to FIG. 10.

Step 1

The system of the present embodiment produces data that specifies one reference voice selected from one or more reference voices (1001). The selected reference voice may be a voice having converted sound quality desired by the user of the system.

Step 2

The system of the present embodiment produces the input voice to be converted (1002). The input voice to be converted may be, for example, the voice of the user, or may be a voice of a person other than the user. In the latter case, for example, the input voice to be converted may be a voice obtained by a call from a third party, but is not limited thereto.

Step 3

Next, the system of the present embodiment converts the input voice to be converted by using data based on the selected reference voice (1003). The data based on the reference voice may be in various modes. Here, the input voice to be converted is X₄.

For example, as described above, the selected reference voice (here, X₃) itself is used, and the application of the following functions may be performed by a program.

B(E₁(X₃), E₂(X₃))=μ₃

A(E₁(X₄), μ₃)=S′₄

D(E₁(X₄), S′₄)=X′₄

In addition, for example, the reference parameter μ₃ generated in advance using the selected reference voice may be used, and the application of the following functions may be performed by a program. There is an advantage that it is not necessary to store the reference voice itself for generating the reference parameter μ₃. Note that, even in this case, a reference voice for allowing the user to understand the reference voice may be stored as described later.

A(E₁(X₄), μ₃)=S′₄

D(E₁(X₄), S′₄)=X′₄

Furthermore, for example, application of a function including application of the following function Aμ₃ in which the reference parameter μ₃ generated based on the selected reference voice is incorporated into the function A may be performed by a program. In this way, in a case of using a function in which the reference parameter μ₃ is already used in the computing process, there is an advantage that substantially equivalent functions can be implemented without using the reference parameter μ₃ itself.

Aμ₃(E₁(X₄)=S′₄

D(E₁(X₄), S′₄)=X′₄

Similarly, a program corresponding to a function in which the reference parameter μ₃ generated based on the selected reference voice is incorporated into the functions A and D may be used.

D·Aμ₃(E₁(X₄))

Note that, in this case, a program corresponding to a function in which E₁ is also combined with the function D or Aμ₃ may be used.

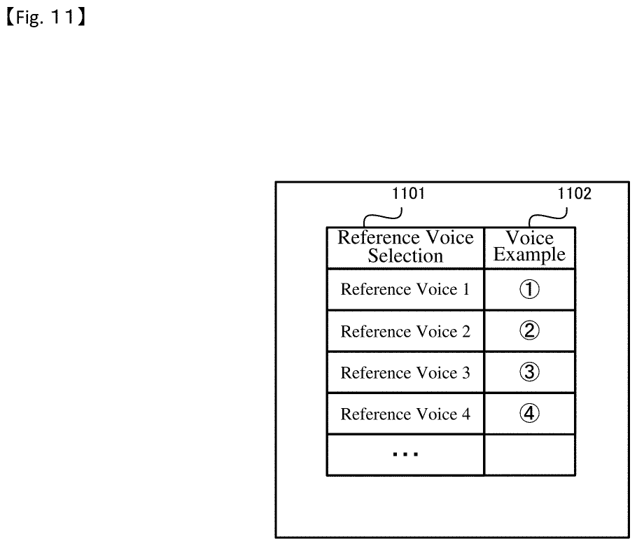

FIG. 11 is an example of an operation face using the system of the present embodiment. Such a face may be an electronic screen that is electronically displayed or may be a physical operation panel. Here, the former case will be described. In addition, such an operation screen may be a touch panel or may be selected by an instruction pointer associated with a mouse or the like.

For example, the operation data can include one or more of the following: data indicative of how the distributor has swiped a touch pad display, data indicative of which object the distributer has tapped or clicked, or data indicative of how the distributor has dragged a touch pad display, or other such operation data.

In the drawing, reference voice selection 1101 indicates that the reference voice can be selected, and any one of reference voices 1 to 4 may be able to be selected. Furthermore, voice examples 1102 may include examples of the respective reference voices. Such voice examples enable the user of the system to understand to which voice the conversion is to be made, which is advantageous. In this case, the system of the present embodiment may store the reference voice that can be easily understood by the user. The reference voice that can be easily understood by the user may be, for example, the reference voice of about 5 seconds or 10 seconds in terms of time. The reference voice that can be easily understood by the user may the characterized reference voice. Examples of the characterized reference voice include, in a case where the reference voice is a voice of an animation character, a voice of the character that sounds like it is said as a line in the animation or a voice of the character speaking the line. In short, it is sufficient that a person who hears the reference voice can understand who the voice is. In this case, the system of the present embodiment may store the reference voice that can be easily understood by the user in association with a characteristic indicating the reference voice, and may utter the reference voice in a case where the reference voice is specified as the voice example.

As described above, the data based on the reference voice may be the reference voice itself, may be the reference parameter μ₃ based on the reference voice, or may be a program module corresponding to one in which the reference parameter μ₃ is applied to the function A and/or the function B.

The production mode may be download from the Internet or input of a file via a recording medium.

Note that, for the system according to the disclosed technology, the inventor confirmed that the voice of the user can be converted into a voice of a style related to the reference data by performing learning using VCTK data and six recitation CDs as the training data, and by using data of about 1 minute corresponding to 20 utterances from the recitation CDs as the reference data.

A terminal device according to an aspect includes: a processor, in which the processor executes a computer-readable command to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder.

A terminal device according to another aspect includes: a processor, in which the processor executes a computer-readable command to: produce an input voice to be converted; and generate a voice by using the input voice to be converted and the first encoder for which a weight related to the first encoder and a weight related to the second encoder are adjusted so as to decrease a reconstruction error between a first voice and a generated first voice to be smaller than a predetermined value, and the generated first voice is generated by using first language data produced from the first voice by using the first encoder, second language data produced from a second voice by using the first encoder, and second non-language data produced from the second voice by using the second encoder.

A terminal device according to another aspect includes: a processor, in which the processor executes a computer-readable command to: produce a reference voice; and generate a reference parameter μ by using the first encoder and the second encoder for which a weight related to the first encoder and a weight related to the second encoder are adjusted so as to decrease a reconstruction error between a first voice and a generated first voice to be smaller than a predetermined value, the reference parameter μ is generated by using reference language data generated by applying the first encoder to the reference voice, and reference non-language data generated by applying the second encoder to the reference voice, and the generated first voice is generated by using first language data produced from the first voice by using the first encoder, second language data produced from a second voice by using the first encoder, and second non-language data produced from the second voice by using the second encoder.

A terminal device according to another aspect includes: a processor, in which the processor executes a computer-readable command to: produce an input voice to be converted; produce language data of input voice from the input voice to be converted by using a first encoder configured to produce language data from a voice; and generate a converted voice by using the language data of input voice and data based on a reference voice.

4-5. Various Implementations

A computer program according to a first aspect is “executed by a processor to: adjust a weight related to a first encoder and a weight related to a second encoder so as to decrease a reconstruction error between a first voice and a generated first voice to be smaller than a predetermined value, in which the generated first voice is generated by using first language data produced from the first voice by using the first encoder, second language data produced from a second voice by using the first encoder, and second non-language data produced from the second voice by using the second encoder”.

A computer program according to a second aspect is “executed by a processor to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder”.

According to the first aspect or the second aspect, in a computer program according to a third aspect, “the generated first voice is generated by using a second parameter μ generated by applying the second language data and the second non-language data to a first predetermined function”.

According to any one of the first to third aspects, in a computer program according to a fourth aspect, “the generated first voice is generated by using first generated non-language data generated by applying the first language data and the second parameter μ to a second predetermined function”.

According to any one of the first to fourth aspects, in a computer program according to a fifth aspect, “the generated first voice is generated by applying the first language data and the first generated non-language data to a decoder”.

According to any one of the first to fifth aspects, in a computer program according to a sixth aspect, “the weight related to the first encoder, the weight related to the second encoder, and a weight related to the decoder are adjusted by back propagation”.

According to any one of the first to sixth aspects, in a computer program according to a seventh aspect, “the first encoder produces third language data from a third voice, the second encoder produces third non-language data from the third voice, and the first predetermined function generates the second parameter μ by further using the third language data and the third non-language data”.

According to any one of the first to seventh aspects, in a computer program according to an eighth aspect, “the second voice and the third voice are voices of the same person”.

According to any one of the first to eighth aspects, in a computer program according to a ninth aspect, “an input voice to be converted is produced, the first encoder is applied to the input voice to be converted to generate language data of input voice, the language data of input voice and data based on a reference voice are applied to the second predetermined function to generate input voice non-language data, and the decoder is applied to the language data of input voice and the input voice non-language data to generate a converted voice”.

According to any one of the first to ninth aspects, in a computer program according to a tenth aspect, “one option selected from a plurality of options of voices and the input voice to be converted are produced, the first encoder is applied to the input voice to be converted to generate the language data of input voice, the language data of input voice and the data based on the reference voice related to the selected one option are applied to the second predetermined function to generate input voice generated non-language data, and the decoder is applied to the language data of input voice and the input voice generated non-language data to generate the converted voice”.

According to any one of the first to tenth aspects, in a computer program according to an eleventh aspect, “the data based on the reference voice includes a reference parameter μ, and the reference parameter μ is generated by applying, to the first predetermined function, reference language data generated by applying the reference voice to the first encoder, and reference non-language data generated by applying the reference voice to the second encoder”.

According to any one of the first to eleventh aspects, in a computer program according to a twelfth aspect, “the reference voice is produced, the reference language data is generated by applying the reference voice to the first encoder, the reference non-language data is generated by applying the reference voice to the second encoder, and the reference parameter μ is generated by applying, to the first predetermined function, the reference language data and the reference non-language data”.

A computer program according to a thirteenth aspect is “executed by a processor to: produce an input voice to be converted; and generate a converted voice by using an adjusted first encoder and the input voice to be converted, in which the adjusted first encoder is adjusted so as to decrease a reconstruction error between a first voice and a generated first voice to be smaller than a predetermined value, and the generated first voice is generated by using first language data produced from the first voice by using the first encoder, second language data produced from a second voice by using the first encoder, and second non-language data produced from the second voice by using a second encoder”.

According to the thirteenth aspect, in a computer program according to a fourteenth aspect, “the first encoder is applied to the input voice to be converted to generate language data of input voice, the language data of input voice and data based on a reference voice are used to generate input voice generated non-language data, and a decoder is applied to the language data of input voice and the input voice generated non-language data to generate the converted voice”.

According to any one of the thirteenth and fourteenth aspects, in a computer program according to a fifteenth aspect, “one option selected from a plurality of options of voices is produced, the first encoder is applied to the input voice to be converted to generate the language data of input voice, the language data of input voice and the data based on the reference voice related to the selected one option are used to generate the input voice generated non-language data, and the decoder is applied to the language data of input voice and the input voice generated non-language data to generate the converted voice”.

According to any one of the thirteenth to fifteenth aspects, in a computer program according to a sixteenth aspect, “the data based on the reference voice includes a reference parameter μ, and the reference parameter μ is generated by using reference language data generated by applying the reference voice to the first encoder, and reference non-language data generated by applying the reference voice to the second encoder”.

A computer program according to a seventeenth aspect is “executed by a processor to: produce a reference voice; and generate a reference parameter μ by using a first encoder and a second encoder for which a weight related to the first encoder and a weight related to the second encoder are adjusted so as to decrease a reconstruction error between a first voice and a generated first voice to be smaller than a predetermined value, in which the generated first voice is generated by using first language data produced from the first voice by using the first encoder, second language data produced from a second voice by using the first encoder, and second non-language data produced from the second voice by using the second encoder, and the reference parameter μ is generated by using reference language data generated by applying the first encoder to the reference voice, and reference non-language data generated by applying the second encoder to the reference voice”.

A computer program according to an eighteenth aspect is “executed by a processor to: produce an input voice to be converted; produce language data of input voice from the input voice to be converted by using a first encoder configured to produce language data from a voice; and generate a converted voice by using the language data of input voice and data based on a reference voice”.

According to the eighteenth aspect, in a computer program according to a nineteenth aspect, “the data based on the reference voice includes a reference parameter μ, and the reference parameter μ is associated with one option selected from a plurality of options of voices”.

According to any one of the eighteenth to nineteenth aspects, in a computer program according to a twentieth aspect, “the data based on the reference voice includes the reference parameter μ, the reference parameter μ is generated by using reference language data and reference non-language data, the reference language data is produced from the reference voice by using the first encoder, and the reference non-language data is produced from the reference voice by using a second encoder configured to produce non-language data from a voice”.

According to any one of the eighteenth to twentieth aspects, in a computer program according to a twenty-first aspect, “a weight related to the first encoder and a weight related to the second encoder are adjusted for the first encoder and the second encoder, respectively, so as to decrease a reconstruction error between a first voice and a generated first voice to be smaller than a predetermined value, and the generated first voice is generated by using first language data produced from the first voice by using the first encoder, second language data produced from a second voice by using the first encoder, and second non-language data produced from the second voice by using the second encoder”.

According to any one of the first to twenty-first aspects, in a computer program according to a twenty-second aspect, “the first predetermined function is a Gaussian mixture model”.

According to any one of the first to twenty-second aspects, in a computer program according to a twenty-third aspect, “the second predetermined function calculates a variance of the second parameter μ”.

According to any one of the first to twenty-third aspects, in a computer program according to a twenty-fourth aspect, “the second predetermined function calculates a covariance of the second parameter μ”.

According to any one of the first to twenty-fourth aspects, in a computer program according to a twenty-fifth aspect, “the second non-language data depends on time data of the second voice”.

According to any one of the first to twenty-fifth aspects, in a computer program according to a twenty-sixth aspect, “the processor is a central processing unit (CPU), a microprocessor, or a graphics processing unit (GPU)”.

According to any one of the first to twenty-sixth aspects, in a computer program according to a twenty-seventh aspect, “the processor is mounted on a smartphone, a tablet PC, a mobile phone, or a personal computer”.

A trained machine learning model according to a twenty-eighth aspect is “executed by a processor to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder”.

A trained machine learning model according to a twenty-ninth aspect is “executed by a processor to: produce an input voice to be converted; and generate a voice by using the input voice to be converted and the first encoder for which a weight related to the first encoder and a weight related to the second encoder are adjusted so as to decrease a reconstruction error between a first voice and a generated first voice to be smaller than a predetermined value, in which the generated first voice is generated by using first language data produced from the first voice by using the first encoder, second language data produced from a second voice by using the first encoder, and second non-language data produced from the second voice by using the second encoder”.

A trained machine learning model according to a thirtieth aspect is “executed by a processor to: produce a reference voice; and generate a reference parameter μ by using the first encoder and the second encoder for which a weight related to the first encoder and a weight related to the second encoder are adjusted so as to decrease a reconstruction error between a first voice and a generated first voice to be smaller than a predetermined value, in which the reference parameter μ is generated by using reference language data generated by applying the first encoder to the reference voice, and reference non-language data generated by applying the second encoder to the reference voice, and the generated first voice is generated by using first language data produced from the first voice by using the first encoder, second language data produced from a second voice by using the first encoder, and second non-language data produced from the second voice by using the second encoder”.

A server device according to a thirty-first aspect includes: “a processor, in which the processor executes a computer-readable command to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder”.

A server device according to a thirty-second aspect includes: “a processor, in which the processor executes a computer-readable command to: produce an input voice to be converted; and generate a voice by using the input voice to be converted and the first encoder for which a weight related to the first encoder and a weight related to the second encoder are adjusted so as to decrease a reconstruction error between a first voice and a generated first voice to be smaller than a predetermined value, and the generated first voice is generated by using first language data produced from the first voice by using the first encoder, second language data produced from a second voice by using the first encoder, and second non-language data produced from the second voice by using the second encoder”.

A server device according to a thirty-third aspect includes: “a processor, in which the processor executes a computer-readable command to: produce a reference voice; and generate a reference parameter μ by using the first encoder and the second encoder for which a weight related to the first encoder and a weight related to the second encoder are adjusted so as to decrease a reconstruction error between a first voice and a generated first voice to be smaller than a predetermined value, the reference parameter μ is generated by using reference language data generated by applying the first encoder to the reference voice, and reference non-language data generated by applying the second encoder to the reference voice, and the generated first voice is generated by using first language data produced from the first voice by using the first encoder, second language data produced from a second voice by using the first encoder, and second non-language data produced from the second voice by using the second encoder”.

A server device according to a thirty-fourth aspect includes: “a processor, in which the processor executes a computer-readable command to: produce an input voice to be converted; produce language data of input voice from the input voice to be converted by using a first encoder configured to produce language data from a voice; and generate a converted voice by using the language data of input voice and data based on a reference voice”.

A program generation method according to a thirty-fifth aspect is “executed by a processor that executes a computer-readable command, the program generation method including: generating a program configured to produce first language data from a first voice by using a first encoder, produce second language data from a second voice by using the first encoder, produce second non-language data from the second voice by using a second encoder, generate a reconstruction error between the first voice and a generated first voice generated using the first language data, the second language data, and the second non-language data, and adjust a weight related to the first encoder and a weight related to the second encoder in such a manner that the reconstruction error is a predetermined value or less”.

A program generation method according to a thirty-sixth aspect is “executed by a processor that executes a computer-readable command, the program generation method including: generating a program configured to produce a reference voice and generate a voice corresponding to a case where an input voice to be converted is produced using the reference voice and the first encoder for which a weight related to the first encoder and a weight related to the second encoder are adjusted so as to decrease a reconstruction error between a first voice and a generated first voice to be smaller than a predetermined value, in which the generated first voice is generated by using first language data produced from the first voice by using the first encoder, second language data produced from a second voice by using the first encoder, and second non-language data produced from the second voice by using the second encoder”.

A method according to a thirty-seventh aspect is “executed by a processor that executes a computer-readable command, in which the processor executes the command to: produce first language data from a first voice by using a first encoder; produce second language data from a second voice by using the first encoder; produce second non-language data from the second voice by using a second encoder; generate a reconstruction error between the first voice and a generated first voice generated using the first language data, the second language data, and the second non-language data; and adjust a weight related to the first encoder and a weight related to the second encoder”.

A method according to a thirty-eighth aspect is “executed by a processor that executes a computer-readable command, in which the processor executes the command to: produce an input voice to be converted; and generate a voice by using the input voice to be converted and the first encoder for which a weight related to the first encoder and a weight related to the second encoder are adjusted so as to decrease a reconstruction error between a first voice and a generated first voice to be smaller than a predetermined value, and the generated first voice is generated by using first language data produced from the first voice by using the first encoder, second language data produced from a second voice by using the first encoder, and second non-language data produced from the second voice by using the second encoder”.

A method according to a thirty-ninth aspect is “executed by a processor that executes a computer-readable command, the method including: producing a reference voice; and generating a reference parameter μ by using the first encoder and the second encoder for which a weight related to the first encoder and a weight related to the second encoder are adjusted so as to decrease a reconstruction error between a first voice and a generated first voice to be smaller than a predetermined value, the reference parameter μ is generated by using reference language data generated by applying the first encoder to the reference voice, and reference non-language data generated by applying the second encoder to the reference voice, and the generated first voice is generated by using first language data produced from the first voice by using the first encoder, second language data produced from a second voice by using the first encoder, and second non-language data produced from the second voice by using the second encoder”.

A method according to a fortieth aspect is “executed by a processor that executes a computer-readable command, the method including: producing an input voice to be converted; producing language data of input voice from the input voice to be converted by using a first encoder configured to produce language data from a voice; and generating a converted voice by using the language data of input voice and data based on a reference voice”.

In the present specification, the first language data may be first language data, the second language data may be second language data, and similarly, n-th language data may be n-th language data (n is an integer). Further, the first non-language data may be first non-language data, the second non-language data may be second non-language data, and similarly, n-th non-language data may be n-th non-language data (n is an integer). Further, the reference language data may be reference language data, and the reference non-language data may be reference non-language data.

In addition, the technology disclosed in the present specification may be used in a game executed by a computer.

Furthermore, the data processing described in the present specification may be implemented by software, hardware, or a combination thereof, processing and procedures of the data processing may be implemented as computer programs, the computer program may be executed by various computers, and these computer programs may be stored in a storage medium. In addition, these programs may be stored in a non-transitory or temporary storage medium.

What has been described in the present specification is not limitative, and it goes without saying that the disclosed technology can be applied to various examples within the scope of various technical ideas having various technical advantages and configurations described in the present specification.

In view of the many possible embodiments to which the principles of the disclosed subject matter may be applied, it should be recognized that the illustrated embodiments are only preferred examples and should not be taken as limiting the scope of the scope of the claims to those preferred examples. Rather, the scope of the claimed subject matter is defined by the following claims. We therefore claim as our invention all that comes within the scope of these claims.

Reference Signs List
1 System
10 Communication network
20 (20A to 20C) Server device
30 (30A to 30C) Terminal device
21 (31) Arithmetic device
22 (32) Main storage device
23 (33) Input/output interface
24 (34) Input device
25 (35) Auxiliary storage device
26 (36) Output device
41 Learning data production unit 41
42 Reference data production unit 42
43 Conversion target data production unit 43
44 Machine learning unit 44

1. Computer-readable storage media storing computer-readable instructions, which when executed by a processor, cause the processor to:
produce first language data from a first voice by using a first encoder;
produce second language data from a second voice by using the first encoder;
produce second non-language data from the second voice by using a second encoder;
generate a reconstruction error between the first voice and a generated first voice generated using the first language data, the second language data, and the second non-language data; and
adjust a weight in a trained machine learning model implemented by a machine learning unit related to the first encoder and a weight in a trained machine learning model implemented by a machine learning unit related to the second encoder.

2. (canceled)

3. The computer readable storage media according to claim 1, wherein:
the generated first voice is generated by using a second parameter μ generated by applying the second language data and the second non-language data to a first predetermined function.

4. The computer readable storage media according to claim 3, wherein:
the generated first voice is generated by using first generated non-language data generated by applying the first language data and the second parameter μ to a second predetermined function.

5. The computer readable storage media according to claim 4, wherein:
the generated first voice is generated by applying the first language data and the first generated non-language data to a decoder.

6. The computer readable storage media according to claim 5, wherein:
the weight related to the first encoder, the weight related to the second encoder, and a weight related to the decoder are adjusted by back propagation.

7. The computer readable storage media according to claim 4, wherein:
the first encoder produces third language data from a third voice, the second encoder produces third non-language data from the third voice, and the first predetermined function generates the second parameter μ by further using the third language data and the third non-language data.

8. The computer readable storage media according to claim 7, wherein:
the second voice and the third voice are voices of the same person.

9. The computer readable storage media according to claim 5, wherein:
an input voice to be converted is produced,
the first encoder is applied to the input voice to be converted to generate language data of input voice,
the language data of input voice and data based on a reference voice are applied to the second predetermined function to generate input voice non-language data, and
the decoder is applied to the language data of input voice and the input voice non-language data to generate a converted voice.

10. The computer readable storage media according to claim 5, wherein:
one option selected from a plurality of options of voices and the input voice to be converted are produced,
the first encoder is applied to the input voice to be converted to generate the language data of input voice, the language data of input voice and the data based on the reference voice related to the selected one option are applied to the second predetermined function to generate input voice generated non-language data, and the decoder is applied to the language data of input voice and the input voice generated non-language data to generate the converted voice.

11. The computer readable storage media according to claim 7, wherein:
the data based on the reference voice includes a reference parameter μ, and the reference parameter μ is generated by applying, to the first predetermined function, reference language data generated by applying the reference voice to the first encoder, and reference non-language data generated by applying the reference voice to the second encoder.

12. The computer readable storage media according to claim 4, wherein
the reference voice is produced,
the reference language data is generated by applying the reference voice to the first encoder,
the reference non-language data is generated by applying the reference voice to the second encoder, and
the reference parameter μ is generated by applying, to the first predetermined function, the reference language data and the reference non-language data.

13-18. (canceled)

19. The computer readable storage media according to claim 11, wherein:
the reference parameter μ is associated with one option selected from a plurality of options of voices.

20. (canceled)

21. (canceled)

22. The computer readable storage media according to claim 3, wherein:
the first predetermined function is a Gaussian mixture model.

23. The computer readable storage media according to claim 4, wherein:
the second predetermined function calculates a variance of the second parameter μ.

24. The computer readable storage media according to claim 4, wherein:
the second predetermined function calculates a covariance of the second parameter μ.

25. The computer readable storage media according to claim 1, wherein:
the second non-language data depends on time data of the second voice.

26. The computer readable storage media according to claim 1, wherein:
the first encoder and the second encoder have weights determined by back propagation by a deep learning machine learning model; and
the deep learning machine learning model is trained with parallel training data.

27. The computer readable storage media according to claim 1, wherein:
the language data is text data; and
the non-language data includes sound quality and intonation, and is distinct from the language data.

28-30. (canceled)

31. A
system comprising a processor and memory, the memory storing computer-readable instructions that when executed cause the processor to:
produce first language data from a first voice by using a first encoder;
produce second language data from a second voice by using the first encoder;
produce second non-language data from the second voice by using a second encoder;
generate a reconstruction error between the first voice and a generated first voice generated using the first language data, the second language data, and the second non-language data; and
adjust a weight related to the first encoder and a weight related to the second encoder.

32-36. (canceled)

37. A computer-implemented method comprising:
by a processor:
producing first language data from a first voice by using a first encoder;
producing second language data from a second voice by using the first encoder;
producing second non-language data from the second voice by using a second encoder;
generating a reconstruction error between the first voice and a generated first voice generated using the first language data, the second language data, and the second non-language data; and
adjusting a weight related to the first encoder and a weight related to the second encoder.

38-40. (canceled)

41. The method of claim 37, further comprising, by the processor:
storing the weights related to the first encoder or to the second encoder in a computer-readable storage medium.

42. The method of claim 37, wherein the weights are weight in a trained machine-learning model, the method further comprising, by the processor:
storing the trained machine-learning model in a computer-readable storage medium.

43. The method of claim 37, further comprising:
converting voice using a machine-learning model comprising the adjusted weights.

44. The method of claim 37, further comprising:
converting voice using a machine-learning model comprising the adjusted weights; and
transmitting the converted voice to a third party via a computer network.

45. The method of claim 37, further comprising:
outputting audio of converted voice, the converted voice being converted by using a machine-learning model comprising the adjusted weights.
